(19) United States
(12) Patent Application Publication
(10) Pub. No.: US 2025/0175115 A1
(43) Pub. Date: May 29, 2025

(54) VARIABLE ANGLE SUPPORT SYSTEM FOR SOLAR ENERGY MODULES

(71) Applicant: Pegasus Solar Inc, Richmond, CA (US)

(72) Inventor: Erich Kai Stephan, Richmond, CA (US)

(21) Appl. No.: 18/963,081

(22) Filed: Nov. 27, 2024

Related U.S. Application Data
(60) Provisional application No. 63/604,046, filed on Nov. 29, 2023.

(51) Int. Cl. H02S 20/10

(52) U.S. Cl. CPC H02S 20/10

(57) ABSTRACT

Systems for solar energy support are provided, as well as methods for installing solar energy support systems. An exemplary solar energy support system may include one or more stilt assemblies installed into an installation surface in a grid pattern, and a plurality of module support assemblies. The one or more stilt assemblies may include each stilt assembly having a stilt of varying height above the installation surface. The stilt assemblies may thus alternate in varying heights. The plurality of module support assemblies may be substantially co-planar, and each module support assembly may include a securing mechanism that secures a solar energy module.

### CROSS-REFERENCE TO RELATED APPLICATION

The present application claims the priority benefit of U.S. Provisional Patent Application No. 63/604,046 filed on Nov. 29, 2023, the disclosure of which is incorporated herein by reference in its entirety.

### BACKGROUND OF THE INVENTION

Currently, solar modules are supported at an angle relative to the horizon set by the geometry of a support bracket. This leads to an inability to maintain a consistent installation angle for a series of solar energy modules when and installation surface is sloped, undulating, or otherwise non-flat. The present invention allows for solar modules to be installed at a common angle relative to the horizon on an installation surface that is either flat or variable in elevation, slope, undulations, or otherwise uneven.

### SUMMARY OF THE CLAIMED INVENTION

Embodiments of the present invention include systems for solar energy support, as well as methods for installing solar energy support systems. An exemplary solar energy support may include one or more stilt assemblies installed into an installation surface in a grid pattern, and a plurality of module support assemblies, each assembled into a column of each stilt. The one or more stilt assemblies may include each stilt assembly having a stilt of varying height above the installation surface. The stilt assemblies may thus alternate in varying heights. The plurality of module support assemblies may be substantially co-planar, and each module support assembly may include a securing mechanism that secures a solar energy module.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1A depicts an isometric view of an exemplary solar module array installed on installation surface.

FIG. 1B depicts a side view of an exemplary solar module array installed on installation surface.

FIG. 2A depicts an exploded view of an exemplary stilt assembly in an unassembled state.

FIG. 2B depicts an isometric view of an exemplary stilt assembly in an assembled state.

FIGS. 3A-3C depict isometric views and a top view of an exemplary support assembly configured onto a stilt.

FIG. 3D depicts an isometric view of an exemplary support assembly with a support receiver.

FIGS. 4A-4B depict a side view and an underside views of an exemplary stilt assembly installed with at least one west facing module and at least one east facing module, both modules angled at a downward angle.

FIG. 4C depicts a side view of an exemplary stilt assembly with solar modules configured at an upward angle.

FIGS. 5A-5C depict end views of various exemplary angle configurations of one or more west facing modules and one or more east facing modules installed on a stilt assembly.

FIGS. 6A-6B depict an isometric underside view and a top view of an exemplary stilt assembly.

FIGS. 7A-7B depict an underside isometric view of a corner position and a top isometric view of a corner position of an exemplary solar module array.

FIGS. 8A-8D depict an isometric view, a side view, a side isometric view, and a partial isometric view of an exemplary solar module array installed onto installation surface.

FIGS. 9A-9C depict a side view, an isometric view, and an isometric view of a corner position of an exemplary solar module array installed at an angle relative to an installation surface.

FIGS. 10A-10B depict an isometric view and a side isometric view of an exemplary ballast container installed onto an exemplary stilt assembly.

FIGS. 11A-11B depict a front isometric view and a side view of an exemplary module clip.

FIGS. 12A-12C depict a side isometric view, a side view, and a front view of an exemplary module clip with vertical flanges configured at an angle.

FIG. 12D depicts a front view of an exemplary module clip with vertical flanges.

FIGS. 13A-13C depict an exemplary installation sequence of a module clip onto a rounded beam with a west facing module installed onto a stilt assembly.

FIGS. 14A-14D depict an exemplary installation method of module clip onto stilt assembly and west facing module.

FIGS. 15A-15C depict exemplary embodiments of a short symmetric support, a tall symmetric support, and an end support.

FIG. 15D depicts an exemplary configuration at the end of an asymmetric support with one or more apertures disposed through a top wall configured with a lock piece and a rounded beam.

FIGS. 16A-16B depict an isometric view and a side view of an exemplary solar module array configured with solar modules at angled orientations.

FIGS. 16C-16D depict a close-up top isometric view and an underside isometric view of an exemplary support installed with four solar modules.

FIGS. 17A-17B depict an isometric view and a side view of an exemplary asymmetric support 1504.

FIGS. 17C-17D depict an isometric view and a side view of an exemplary solar module array with a first north support row and two middle support rows positioned on an installation surface.

FIGS. 17E-17F depict an isometric top down view and an underside view of an asymmetric support with four South-north facing modules.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

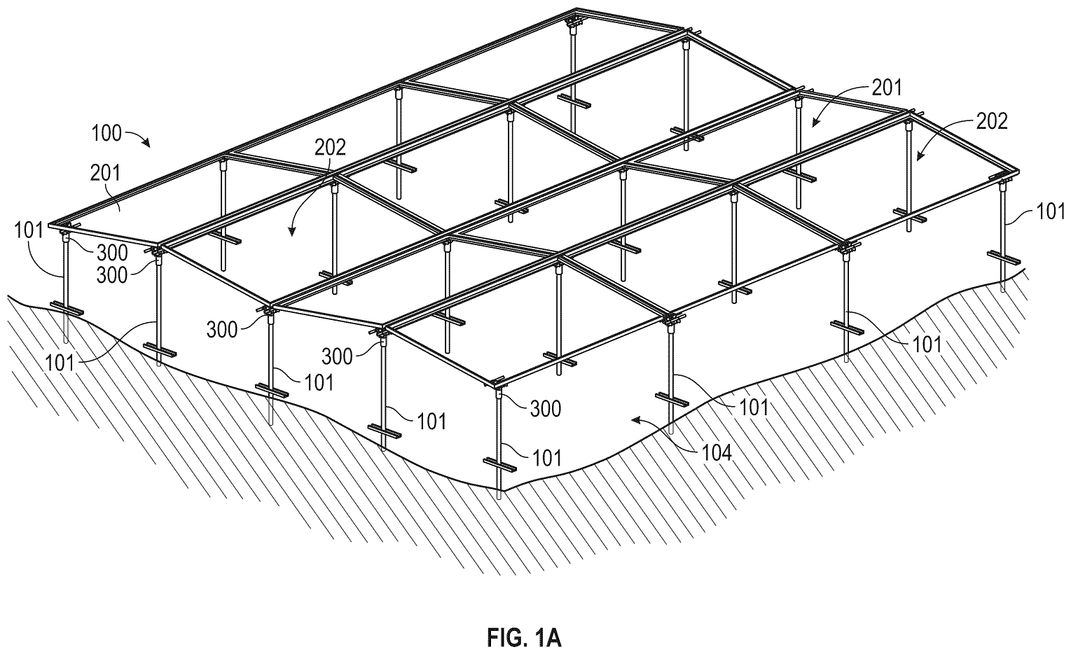

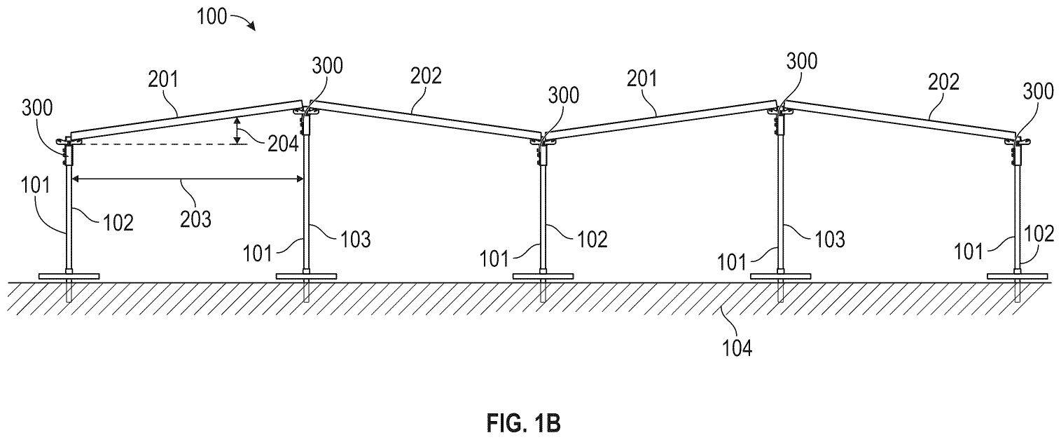

FIG. 1A depicts an isometric view of an exemplary solar module array 100 installed on installation surface 104. A plurality of stilt assembly 101 are disposed on an installation surface 104 in a grid-like pattern. The plurality of stilt assembly 101 supports a plurality of west facing module 201 above installation surface 104 with rows of west facing module 201 adjacent to rows of east facing module 202. Installation surface 104 may be dirt, ungraded land, graded land, concrete, landfill or another suitable installation surface. The plurality of stilt assembly 101 may be installed in a grid-like pattern where columns and rows of stilt assembly 101 are arranged such that stilt assembly 101 is located substantially near a corner of a west facing module 201 or an east facing module 202. The columns and rows of stilt assembly 101 can be arranged in any orientation relative to North-South, but for the ease of description, it will be described wherein rows of stilt assemblies 101 are positioned in an East-West orientation and columns of stilt assemblies 101 are positioned in a North-South orientation. Generally, it is desirable to have west facing module 201 and east facing module 202 angled either towards due West or due East, respectively, in order to maximize power generation from the sun, but it is anticipated that west facing module 201 and east facing module 202 can be oriented at any angle relative to North-South. A first stilt assembly 101 may be positioned at distance closer or near a next stilt assembly 101, and a first support assembly 300 may be positioned at a different elevation than a second support assembly 300 in order to achieve a desired angle of a west facing module 201 or an east facing module 202 relative to earth horizon. The first support assembly 300 may be co-planar with (e.g., within 100 mm of) the second support assembly 300.

FIG. 1B depicts a side view of an exemplary solar module array 100 installed on installation surface 104. As depicted in FIG. 1B, the side view is looking North, demonstrating solar module angle 204 based on East-West stilt spacing 203 of the stilt assembly 101. In this example, stilt assemblies 101 are spaced a East-West stilt spacing 203 such that solar module angle 204 is an angle greater than zero. Stilt assembly 101 may be configured as either a short stilt assembly 102 or a tall stilt assembly 103, where a short stilt assembly 102 extends a shorter distance from installation surface 104 compared to tall stilt assembly 103. Short stilt assembly 102 and tall stilt assembly 103 may alternate along a row of stilt assemblies 101 in order to properly support west facing module 201 and east facing module 202 at their respective distal edges. In some examples, short stilt assembly 102 and tall stilt assembly 103 may be the exact same component, however, short stilt assembly 102 can be driven, pushed, or installed deeper than tall stilt assembly 103 into installation surface 104. In some examples, installation surface 104 can be a substantially flat surface. However, in other examples installation surface 104 may have undulating, uneven, or variable surface elevations, inclinations, or slopes. In this case, stilt assembly 101 may be installed into installation surface 104 at different depths in order for the plurality of support assembly 300 in a column of short stilt assembly 102 to be an average height above a installation surface 104 and a plurality of support assembly 300 in a column of tall stilt assembly 103 to be at a same or higher average height above installation surface 104 relative to the column of short stilt assembly 102. The average height of the short stilt assembly 102 may extend, for example, 100 mm above the installation surface 104.

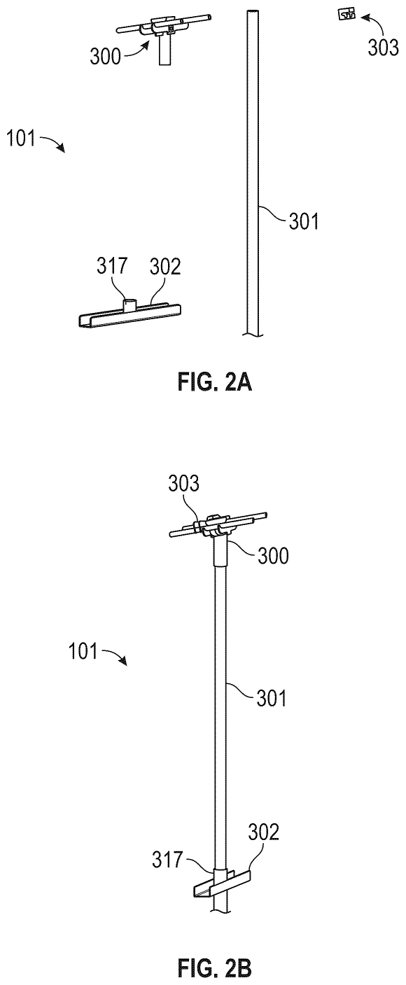

FIG. 2A depicts an exploded view of an exemplary stilt assembly 101 in an unassembled state. In this example embodiment, stilt assembly 101 consists of a support assembly 300, a stilt 301, a ground brace 302, a module clip 303, and a brace crimp tube 317. A ground brace 302 may have a brace crimp tube 317 disposed orthogonal to the main body of ground brace 302. Ground brace 302 may be a rectangular shape as looked from above and may have one or more flanges on the sides, such as on the long sides as depicted, in order to improve the rigidity and moment of inertia of ground brace 302 in the upward direction. Brace crimp tube 317 may have an aperture through the center configured to receive stilt 301. Ground brace 302 may slide onto stilt 301 at any height and brace crimp tube 317 may permanently or demountably secure to stilt 301 at a set or variable location along the length of stilt 301 by crimping, screwing, clamping or otherwise affixing ground brace 302 to stilt 301. brace crimp tube 317 may be a uniform wall thickness material, such as a tube or sheet metal, and may be fused, crimped, welded, threaded, or otherwise suitably permanently fastened to ground brace 302.

FIG. 2B depicts an isometric view of an exemplary stilt assembly in an assembled state. A support assembly 300, a stilt 301, a ground brace 302, a module clip 303, and a brace crimp tube 317 that assemble into a stilt assembly 101 may be manufactured and packaged separately and delivered to a final installation location separately to be installed and assembled together at the installation location.

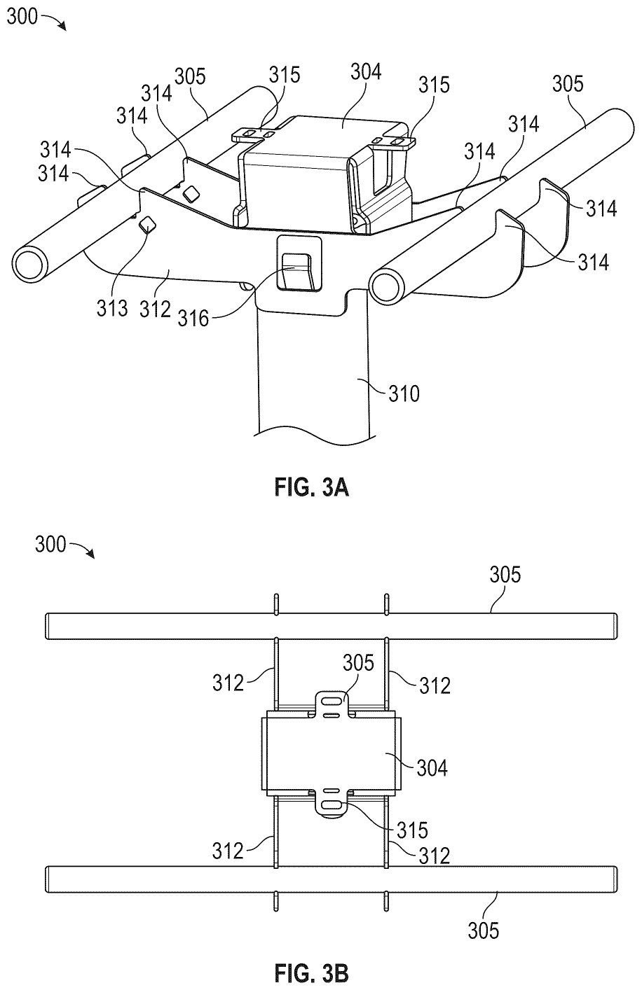

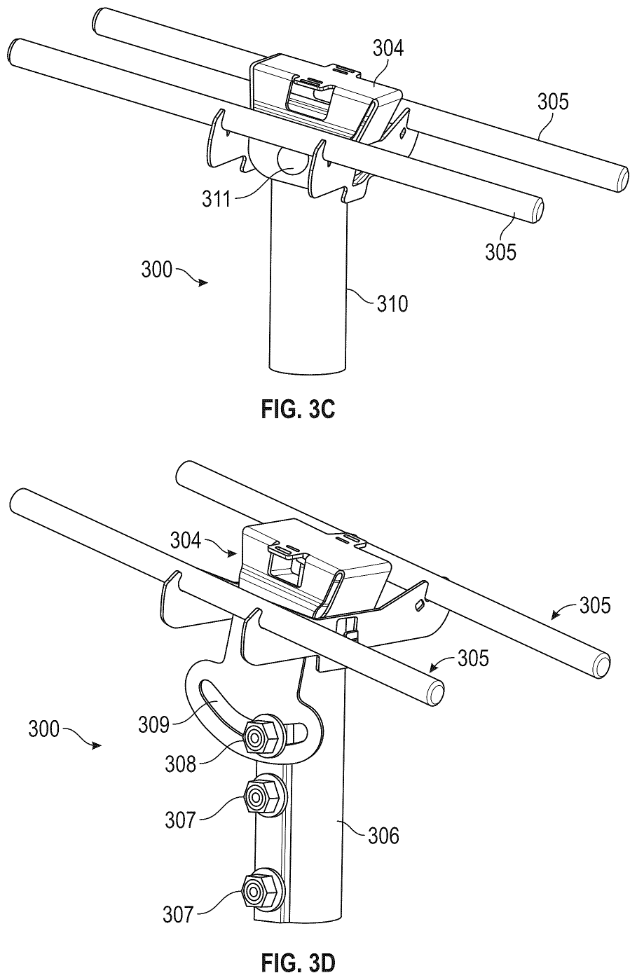

FIGS. 3A-3C depict isometric views and a top view of an exemplary support assembly configured onto a stilt. In some examples, support assembly 300 may be configured to attach onto a stilt 301. In other examples, support assembly 300 may not connect onto stilt 301 and may itself be installed onto an installation surface 104.

The illustrated example embodiments consist of a support bracket 304, one or more rounded beam 305, and support crimp receiver 310. Rounded beam 305 may have one or more support arms 312 extending away from the main body. Support arms 312 may have an aperture formed by one or more beam securement mechanism 314 (e.g., securement flange) that secure rounded beam 305 to support bracket 304. Beam securement mechanism 314 may extend up around the circumference of rounded beam 305 a sufficient distance in order to secure rounded beam 305 from sliding up away from support bracket 304 but may not extend so far up as to interfere with a west facing module 201 that may install or be coincident on a rounded beam 305. Support arms 312 may extend a distance away from the main body of support bracket 304 sufficient to allow a west facing module 201 to rest on a rounded beam 305 and coincide with one or more surfaces on a support bracket 304 in order to position rounded beam 305 in a desired location under the frame of west facing module 201. One or more crimp feature 313 may be disposed on support arms 312 and allow for part of support arms 312 to deform, crimp, threadably engage, or otherwise permanently or demountably secure rounded beam 305 to support bracket 304. Support bracket 304 may have one or more module spacer 315 extending from the main body of support bracket 304. module spacer 315 may be positioned mid plane along the length of rounded beam 305 and act as a spacer between two west facing module 201 installed on one side of a support assembly 300. Module spacer 315 may have an aperture disposed through the surface to receive a tool for bending or removing module spacer 315 from a support bracket 304 in order to allow a west facing module 201 to not interfere with a module spacer 315. For example, module spacer 315 may be removed so support bracket 304 can be positioned along the mid-length of west facing module 201 and not interfere with an otherwise present module spacer 315. One or more other apertures may be disposed through a module spacer 315 near a bend axis in order to facilitate easier bending and removal of a module spacer 315. Cable flange 316 may be formed in the side of one or more support arms 312 and configured to receive a cable or beam or bracket or eyelet or similar component and may be configured to be forcibly compressed or crimped against said component. In some examples, a cable or a beam or a structural member may connect one or more support assembly 300 together at cable flange 316 in order to prevent two or more stilt assembly 101 from traversing laterally relative to one another. In other example embodiments not shown, a demountably installable clip, may secure rounded beam 305 from sliding along its length relative to support bracket 304. The clip may have a second function to also act as a spacer between solar modules. The clip may be made from a flexible metal, such as a lock piece 1514, or may be made from a polymer such as injection molded plastic.

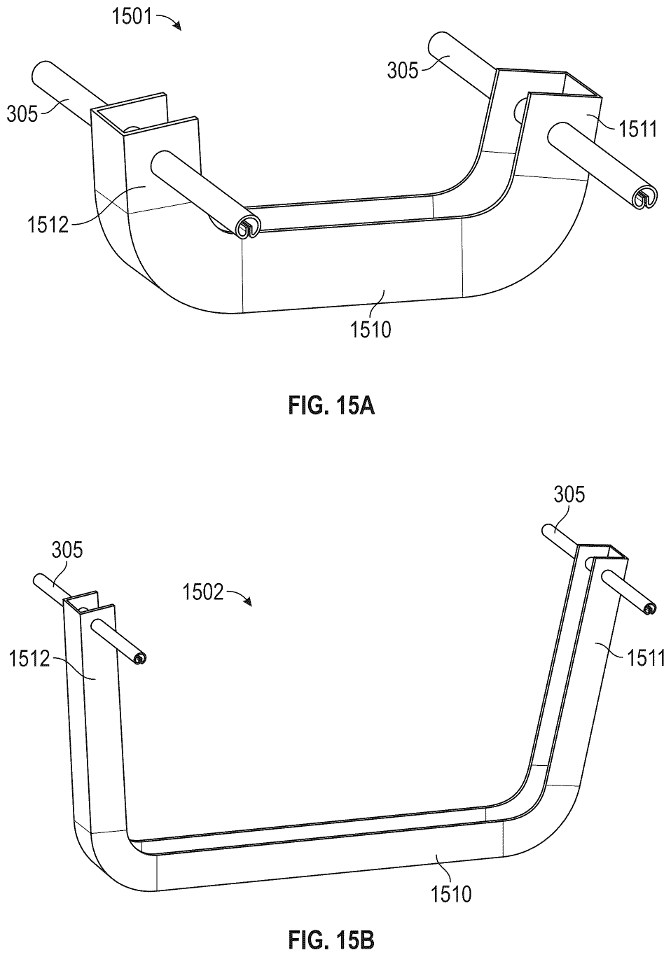

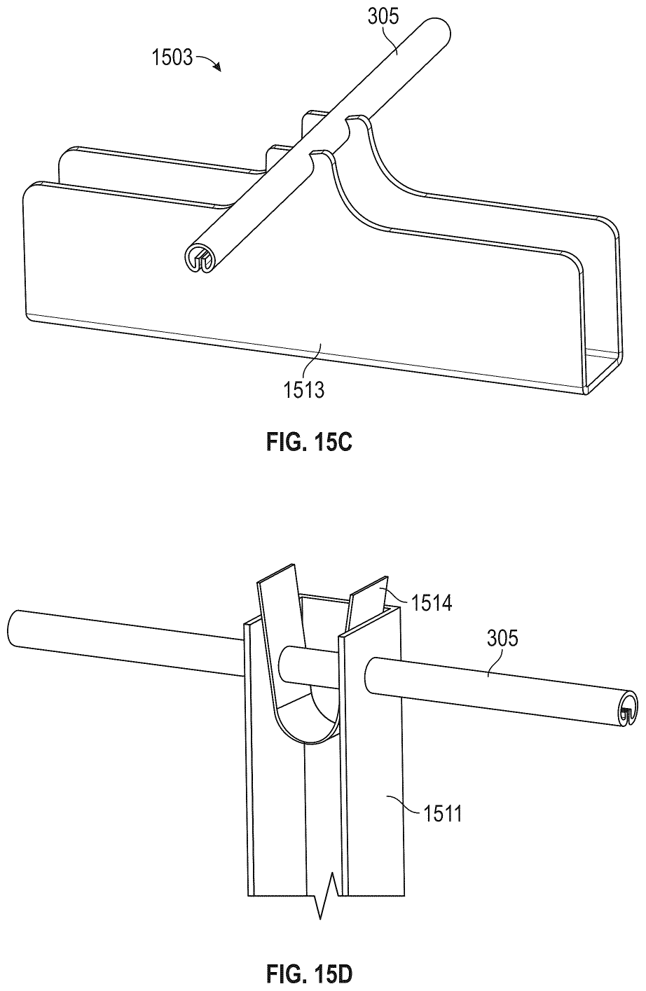

In some example embodiments, support bracket 304 is formed in a single piece out of a uniform thickness material, such as sheet metal. Support bracket 304 may be made of steel, stainless steel, pre-coated steel, aluminum, or plastic. Rounded beam 305 may be solid or hollow, such as a tube or pipe. In some example embodiments not shown, rounded beam 305 has a cross-sectional shape with one or more flat surfaces, such as a hexagon or a “D” shape, or may be elliptical or oblong in shape. Rounded beam 305 may have an upward surface that is curved to allow for a west facing module 201 to rest on the rounded beam 305 and have an even contact surface at any angle of a west facing module 201 relative to support bracket 304 from a wide range of angles, such as −45° to +45°. In other words, west facing module 201 can be evenly supported and can articulate a plurality of angles relative to support bracket 304. Rounded beam 305 may be a solid or a hollow beam, or bar made of steel, aluminum, stainless steel, or a polymer. Rounded beam 305 may be formed from a uniform thickness sheet metal, such as depicted at least in FIGS. 15A-D, from a material of carbon steel, pre-coated steel, aluminum, or stainless steel. Support crimp receiver 310 may be pivotally connected to support bracket 304 with an axis that may be perpendicular to the length of rounded beam 305. Support crimp receiver 310 may be connected to support bracket 304 using one or more rivets, screws, fasteners, formed flanges, or apertures with drawn features extending therein. In other example embodiments not shown, support crimp receiver 310 may be connected to support bracket 304 using a ball and socket type joint wherein support bracket 304 can articulate in any number of angles relative to support crimp receiver 310. In some example embodiments, support bracket 304 may only be able to articulate a desired angle such as up to 45° in any direction, such as if connected to support crimp receiver 310 with a ball and socket joint, or may be limited to articulate along only one axis, such as with a pin or hinge joint, as depicted.

Stilt 301 may be a cylindrical tube that is hollow or solid or stilt 301 may be a non-circular shape. In other example embodiments, stilt 301 may have a cross-section of a C-shape, a square, a curved, a crescent, or a T-shape. Stilt 301 may have one end that is shaped in a tapered, a chisel, a spade, a flattened, a serrated, or a cut-away tip to help be driven into installation surface 104, such as to disperse soil, as stilt 301 is driven into installation surface 104. For example, stilt 301 may be a substantially round shape for the majority of its length and have a spade tip configured to more readily drive into a ground installation surface. Stilt 301 may have a smooth exterior surface or may have a knurled or ribbed or an otherwise textured surface configured to more readily drive into the ground or configured to provide sufficient friction upon support crimp receiver 310 securing onto stilt 301 or brace crimp tube 317 securing onto stilt 301. Stilt 301 may be a common rebar material or may be a custom fabricated component. Stilt 301 may be made of galvanized steel, epoxy coated steel, pre-coated steel, stainless steel, aluminum, or a carbon steel. Stilt 301 may be configured to receive or to accept a tool on an opposite distal end from the end configured to install into installation surface 104. Stilt 301 may have enough flex to position support assembly 300 at a North-South and East-West coordinates different from the point of penetration into installation surface 104 in order to position support assembly 300 against one or more corners or edges of a solar energy module if the corner of a solar energy module is not vertically aligned with the penetration location of a stilt 301 into installation surface 104.

In some examples, the stilt 301 is made of a flexible material that allows a distal end of the stilt 301 to be at a different location in an x-y plane than a location of penetration into the installation surface by the stilt 301 after one or more solar energy modules are installed onto the module support assemblies. Further, the flexibility of the stilt 301 may allow an offset of at least 10 mm in an x-y plane between the distal end and a location of penetration into the installation surface. For example, the distal end of a stilt may deflect at least 10 mm in a east-west or north-south direction relative to the point of penetration in an installation surface without the stilt permanently deforming, or such that the material remains in an elastic range of deformation.

As shown in FIG. 3C, pivot axel 311 connects support bracket 304 to support crimp receiver 310. Support bracket 304 may be able to articulate around the axis of pivot axel 311 relative to support crimp receiver 310 up to an angle until support bracket 304 intentionally interferes with support crimp receiver 310. Support crimp receiver 310 may be formed out of an extrusion, a formed or drawn plate, a tube, or a formed sheet metal. Support crimp receiver 310 may be made of aluminum, steel, stainless steel, or polymer. An aperture may be disposed along the length of support crimp receiver 310 and configured to receive stilt 301. Support crimp receiver 310 may have a material property that is suitable for easily crimping or permanently deforming support crimp receiver 310 onto a stilt 301 in order to permanently or demountably secure and install support assembly 300 onto stilt 301.

FIG. 3D depicts an isometric view of an exemplary support assembly 300 with a support receiver 306. A support receiver 306 may have one or more articulating lock 308 configured to protrude through articulating aperture 309. Support bracket 304 may be pivotably connect to support receiver 306 and articulate along the path of articulating aperture 309. Articulating lock 308 may be threadably engaged with support receiver 306 and upon support bracket 304 being articulated a desired angle, articulating lock 308 may be tightened to secure support bracket 304 at an angle relative to support receiver 306. One or more set screw 307 may be disposed on a different or a same plane as articulating lock 308 and configured to tighten into stilt 301 upon a stilt 301 being inserted into the end of support receiver 306. A support receiver 306 may have an aperture disposed along its length configured to receive stilt 301. Support receiver 306 may be an aluminum extrusion, formed sheet metal, drawn sheet metal, or drawn tube, and may be made of aluminum, steel, stainless steel, or a polymer. As shown in this embodiment, support bracket 304 articulates around an axis relative to support assembly 300 that is perpendicular to the primary axis of rounded beam 305.

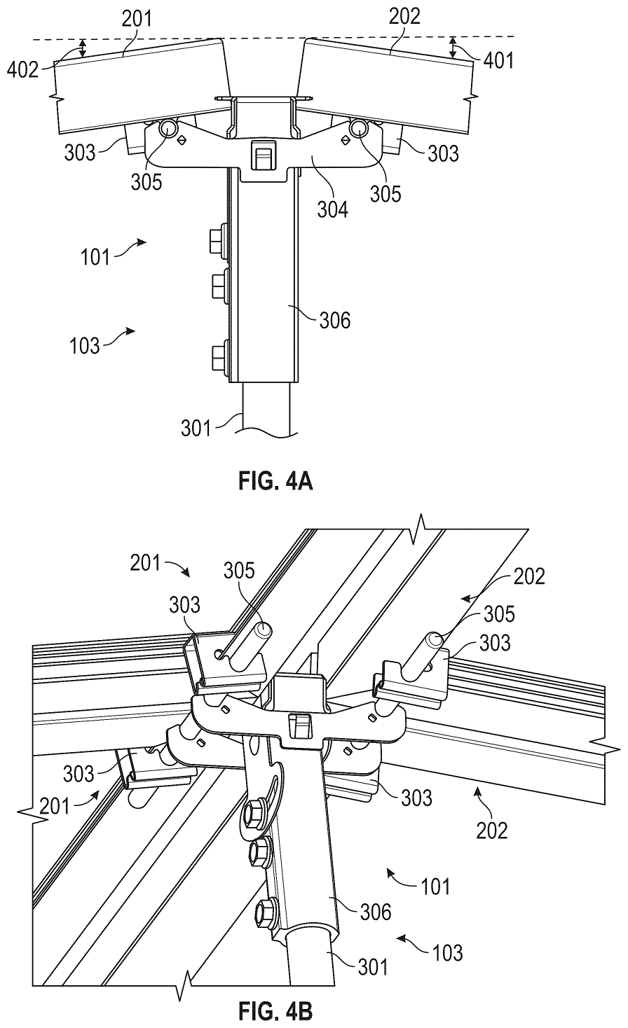

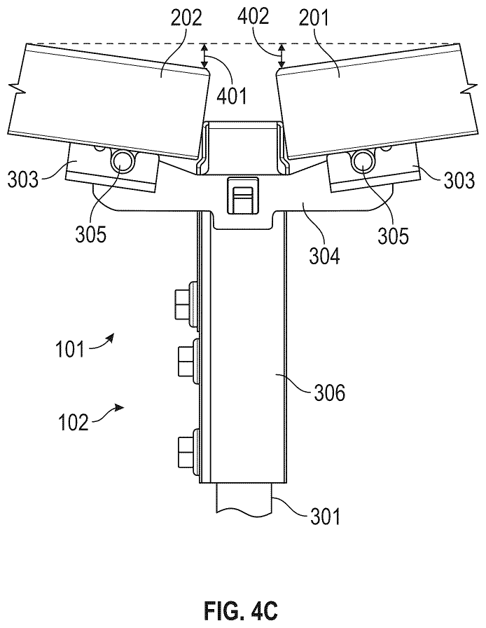

FIGS. 4A-4B depict side and underside views of an exemplary stilt assembly 101 installed with at least one west facing module 201 and at least one east facing module 202, both modules angled at a downward angle.

In FIG. 4A, support bracket 304 is installed on a stilt 301 and configured as a tall stilt assembly 103 wherein a west facing module 201 is angled down from the horizon away from support bracket 304 to form a second module angle 402 and east facing module 202 is angled down from the horizon away from the support bracket 304 to form a first module angle 401. In these example embodiments, west facing module 201 rests on a rounded beam 305 and is coincident with support bracket 304 on its inner lower distal corner. West facing module 201 is secured to rounded beam 305 via one or more module clip 303. Likewise, east facing module 202 rests on an oppositely positioned rounded beam 305 at an angle opposite of west facing module 201 and connected to rounded beam 305 using one or more module clip 303. As depicted, beam securement mechanism 314 does not interfere with the underside of west facing module 201 or east facing module 202.

FIG. 4B depicts an underside view of stilt assembly 101 configured to a tall stilt assembly 103. In this example embodiment, a first west facing module 201 sits atop a first rounded beam 305 and connected with a first module clip 303. A second west facing module 201 is placed on a rounded beam 305 and connected to rounded beam 305 using a second module clip 303. A first west facing module 201 and a second west facing module 201 are spaced a distance apart by module spacer 315. In other example embodiments, a first west facing module 201 and a second west facing module 201 may abut together or may have a small gap that is positioned without any module spacer 315 in the assembly. On the opposite side of stilt assembly 101, two east facing modules 202 rest on a second rounded beam 305. A first east facing module 202 is connected to rounded beam 305 using a third module clip 303 and a second east facing module 202 is connected to a second rounded beam 305 using a fourth module clip 303. The curved upper surface of rounded beam 305 allows for a west facing module 201 or an east facing module 202 to be fully supported when a west facing module 201 or east facing module 202 are at any angle relative to stilt assembly 101 without reconfiguring or changing stilt assembly 101. Module clip 303 may connect and be parallel to west facing module 201 or east facing module 202 at any angle that west facing module 201 or east facing module 202 are positioned relative to stilt assembly 101. In other words, module clip 303 may be pivotably attached to rounded beam 305 and aligned with the angle of west facing module 201.

FIG. 4C depicts a side view of an exemplary stilt assembly 101 installed with at least one west facing module 201 and at least one east facing module 202, both modules angled at an upward angle. In this example embodiment, support bracket 304 is installed on a stilt 301 and configured as a tall stilt assembly 103 wherein a west facing module 201 is angled up to the horizon towards support bracket 304 to form a second module angle 402 and east facing module 202 is angled up to the horizon towards support bracket 304 to form a first module angle 401. In some examples, support receiver 306 may be interchanged with support crimp receiver 310.

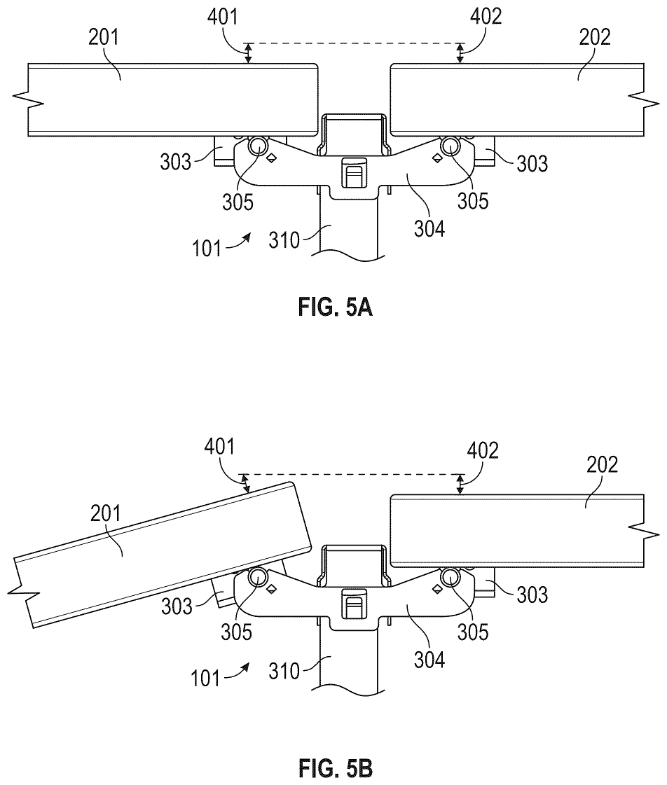

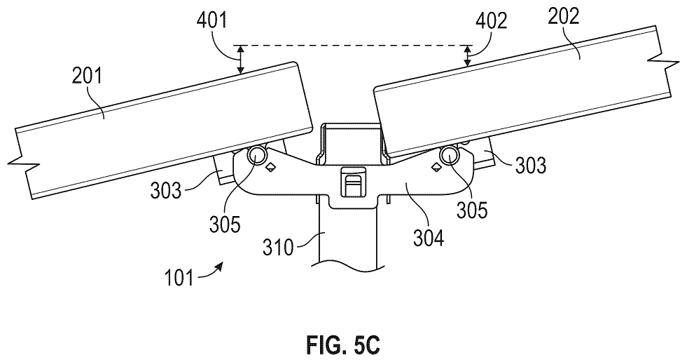

FIGS. 5A-5C depict end views of various exemplary angle configurations of one or more west facing modules 201 and one or more east facing modules 202 installed on a stilt assembly 101. FIG. 5A shows an example embodiment where one or more west facing modules 201 and one or more east facing modules 202 in a flat horizontal position wherein first module angle 401 and second module angle 402 are substantially zero. FIG. 5B depicts an example embodiment wherein west facing module 201 is angled down to the horizon towards support bracket 304 to form a first module angle and east facing module 202 is in a substantially flat horizontal position to make second module angle 402 substantially zero. FIG. 5C depicts an example wherein both west facing module 201 and east facing module 202 are angled facing west. What is depicted throughout FIGS. 4C, 5A, 5B, and 5C are examples of how solar modules on either side of a stilt assembly 101 can be angled independently from one another and at varying angles relative to stilt assembly 101. In all cases and angles depicted throughout FIGS. 4C, 5A, 5B, and 5C, the solar modules are fully supported on rounded beam 305 in all cases, varying angles module clip 303 may be aligned with the respective solar module, and support crimp receiver 310 may be pivotally connected to support bracket 304 with an axis that may be perpendicular to the length of rounded beam 305.

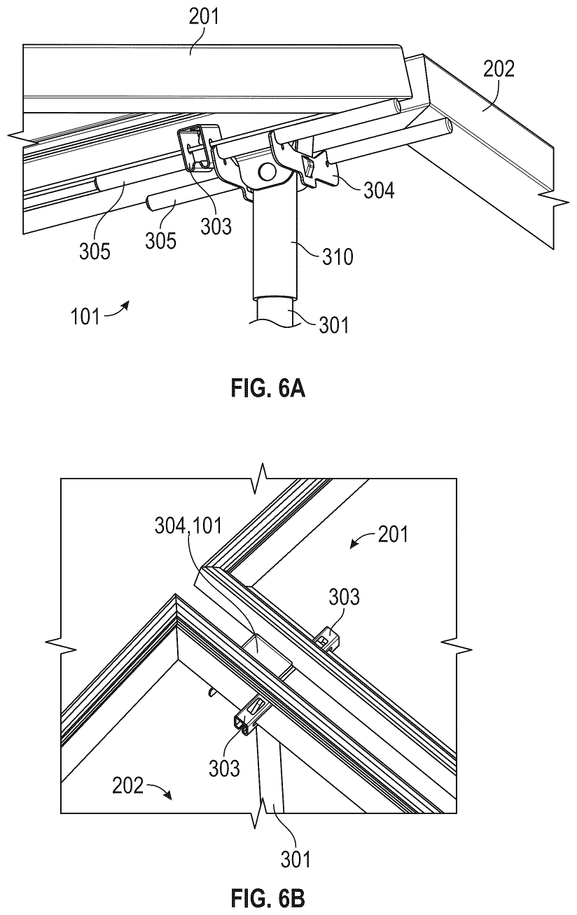

FIGS. 6A-6B depict isometric underside view and a top view of an exemplary stilt assembly 101. FIG. 6A depicts an isometric underside view of an exemplary stilt assembly. In FIG. 6A, the stilt assembly 101 is positioned inside from the edge of west facing module 201 or east facing module 202 such that rounded beam 305 is substantially under west facing module 201 and a second rounded beam 305 is fully under east facing module 202. In this example embodiment, west facing module 201 and east facing module 202 fully contact rounded beam 305. One or more module clips 303 may secure west facing module 201 and east facing module 202 to rounded beam 305. Support bracket 304 is pivotally angled relative to stilt 301 and support crimp receiver 310 and west facing module 201 and east facing module 202 are angled around the axis of rounded beam 305, such that west facing module 201 and east facing module 202 are nonplanar with the axis of stilt 301. FIG. 6B depicts a top view of an exemplary stilt assembly. In this example embodiment, support bracket 304 is positioned between east facing module 202 and west facing module 201.

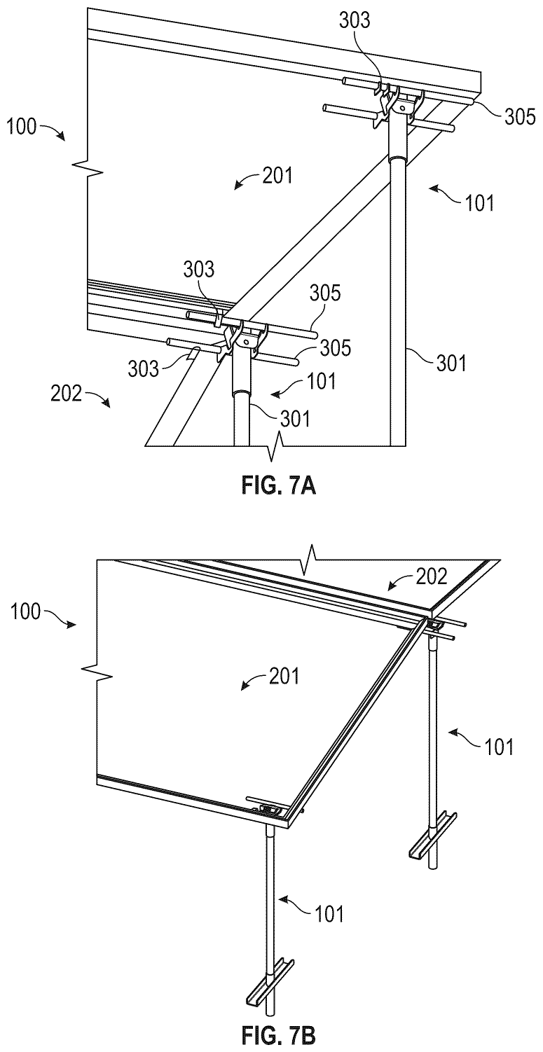

FIGS. 7A-7B depict underside isometric view of a corner position and top isometric view of a corner position of an exemplary solar module array 100. In this example embodiment shown in both views, a first stilt assembly 101 is positioned at a corner of solar module array 100 and in the corner of a west facing module 201 such that rounded beam 305 is positioned fully underneath the perimeter of west facing module 201. A second stilt assembly 101 may be positioned with only part of rounded beam 305 underneath a west facing module 201 and east facing module 202, as shown.

As illustrated in FIG. 7B, at least one of the stilts of the first stilt assembly 101 may be positioned by (e.g., within zero mm to 500 mm of) a corner of the west-facing module 201. At least one of the stilts of the first stilt assembly 101 may be positioned by (e.g., within 500 mm of) a corner of the west-facing module 201. Although the dimensions are described in relation to the first stilt assembly 101 and the west-facing module 201, the dimensions can apply to other stilt assemblies and modules described herein.

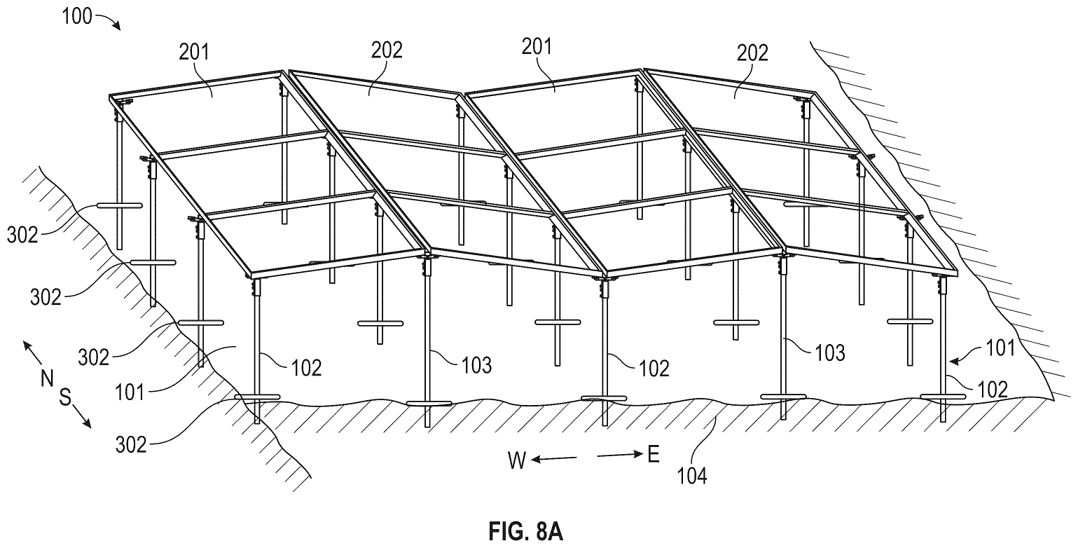

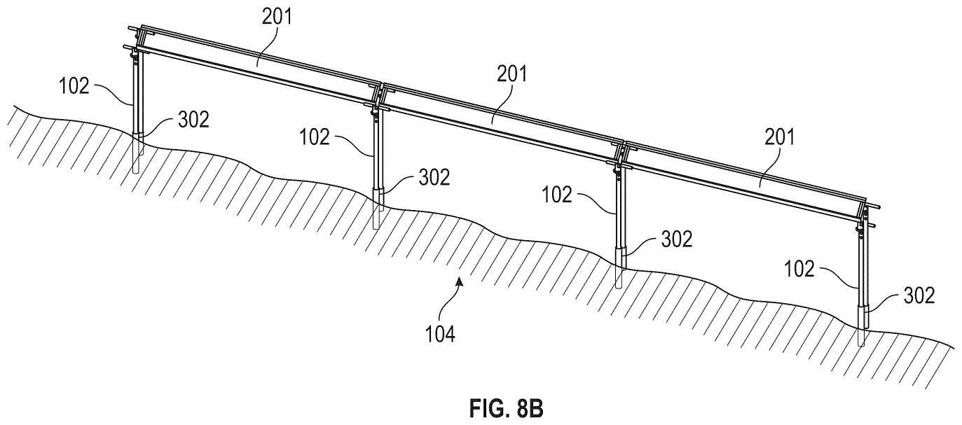

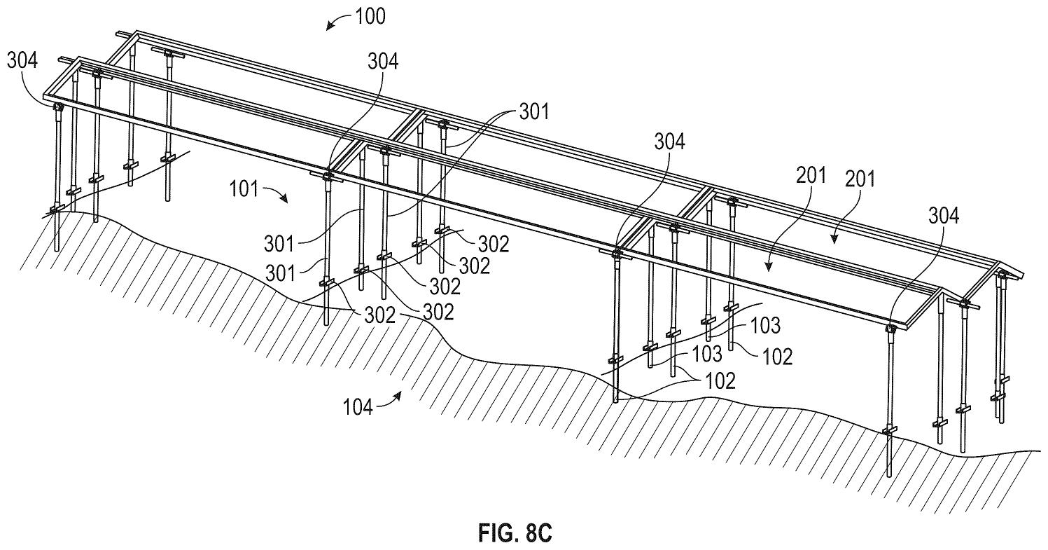

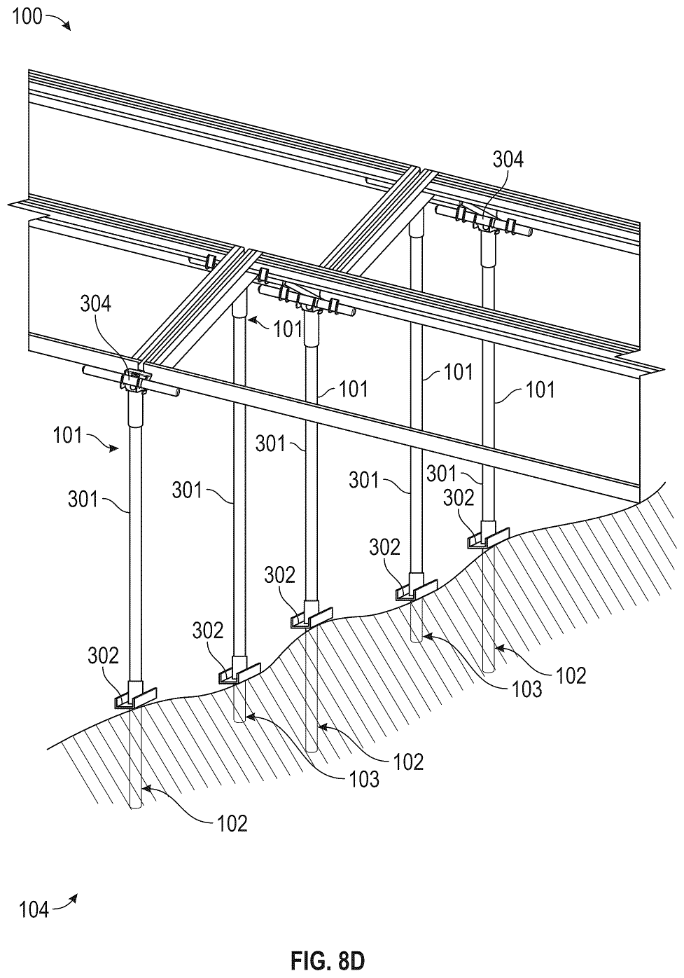

FIGS. 8A-8D depict isometric view, side view, a side isometric view, and a partial isometric view of an exemplary solar module array 100 installed onto installation surface 104. In this example embodiment, stilt assembly 101 may be vertically installed into installation surface 104 wherein stilt assembly 101 is vertical to earth center. Ground brace 302 may be positioned perpendicular to the slope of installation surface 104 such that the long edge of ground brace 302 runs along a substantially similar plane of elevation of installation surface 104. Support bracket 304 may be angle relative to stilt 301 at an angle substantially equal to the average angle of installation surface 104 in order to allow for west facing module 201 and east facing module 202 to be installed in a substantially planner column. A column of short stilt assemblies 102 and a column of tall stilt assemblies 103 may be positioned relative to one another in order to angle west facing module 201 relative to earth horizon at a desired angle and a second row of short stilt assemblies 102 may be positioned relative to 103 to angle a first column of east facing module 202 at a different or equal angle relative to earth horizon. As depicted, short stilt assembly 102 and tall stilt assembly 103 are positioned at similar distance apart to provide a first column of west facing modules 201 and a second column of west facing modules 201 to be at substantially the same angle towards the West and a first column of east facing modules 202 and a second column of east facing modules 202 to be angled at substantially the same angle towards the east relative to earth horizon. In other example embodiments not shown, a column of stilt assemblies 101 and a second column of stilt assemblies 101 may be positioned at a distance apart from one another such that a west facing module 201 is substantially flat relative to earth horizon and in such a way a first column of stilt assemblies 101 and a second column of tilt assemblies 101 are installed into installation surface 104 such that support assembly 300 in a first column and support assembly 300 in a second column are substantially coincident to one another. The height of support assemblies 300 in a column of tall stilt assemblies 103 relative to the height of a support assemblies 300 in a column of short stilt assemblies 102 is thus dictated by the desired angle of a west facing module 201 and East-West stilt spacing 203. In some example embodiments, installation surface 104 may be at an incline in a North-South direction and also add an incline in the East-West direction or may be in a dome, curved, or otherwise complex topography shape. In such example embodiments, the stilt assemblies 101 may be installed at various depths relative to the actual elevation of its installation location such that the various support assemblies 300 on the plurality of stilt assemblies 101 are at desired elevations and angles to allow a column of 201s to be substantially coincident, yet the rows may have varying angles relative to one another and potentially following the curvature or slope of installation surface 104 in an East-West direction. As depicted in FIG. 8C, a common stilt 301 may be used for all stilt assembly 101 but may extend below ground brace 302 at varying distances in order to achieve a desired height of a support assembly 300.

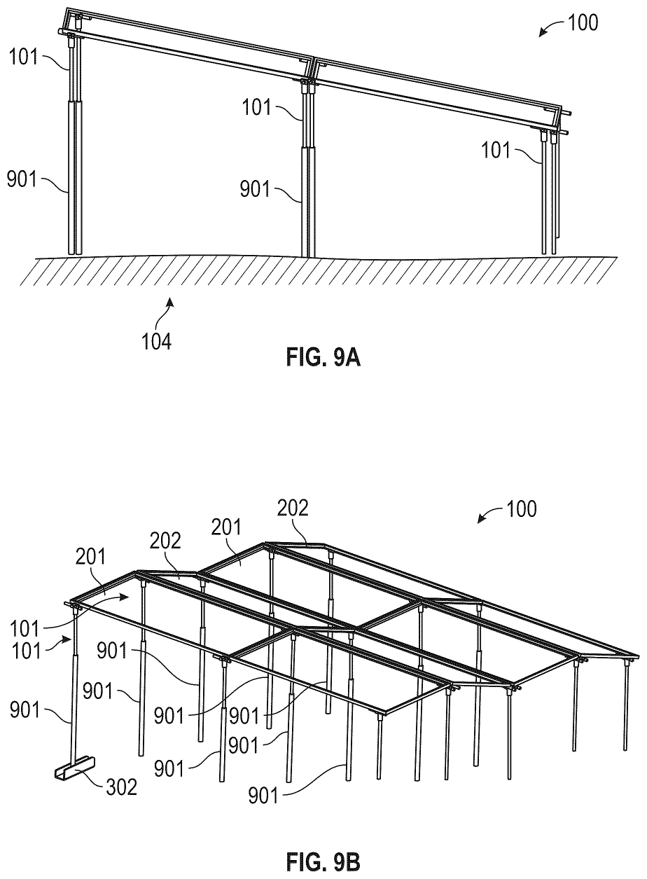

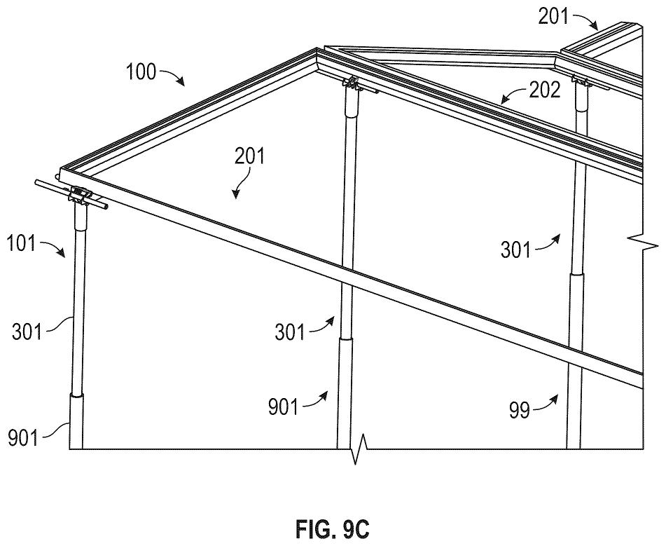

FIGS. 9A-9C depict a side view, an isometric view, and an isometric view of a corner position of an exemplary solar module array 100 installed at an angle relative to an installation surface 104. In this example embodiment, stilt extension 901 is installed onto stilt 301 in order to angle solar module array 100 relative to installation surface 104. Stilt extension 901 may be a cylindrical tube or a stamped form of sheet metal or a bracket or extruded beam that secures two stilt assemblies 101 on a first end and installs into installation surface 104 on a second end. A ground brace 302 may be installed onto a stilt extension 901 in one or more locations. As shown in FIG. 9A, a first row of stilt assemblies 101 may be installed to installation surface 104 without a stilt extensions 901 then a second row of stilt assemblies 101 may have stilt extensions 901 installed at a first height and a third row of stilt assemblies 101 may have stilt extensions 901 installed at a second height in order for the columns of solar modules to be substantially planar.

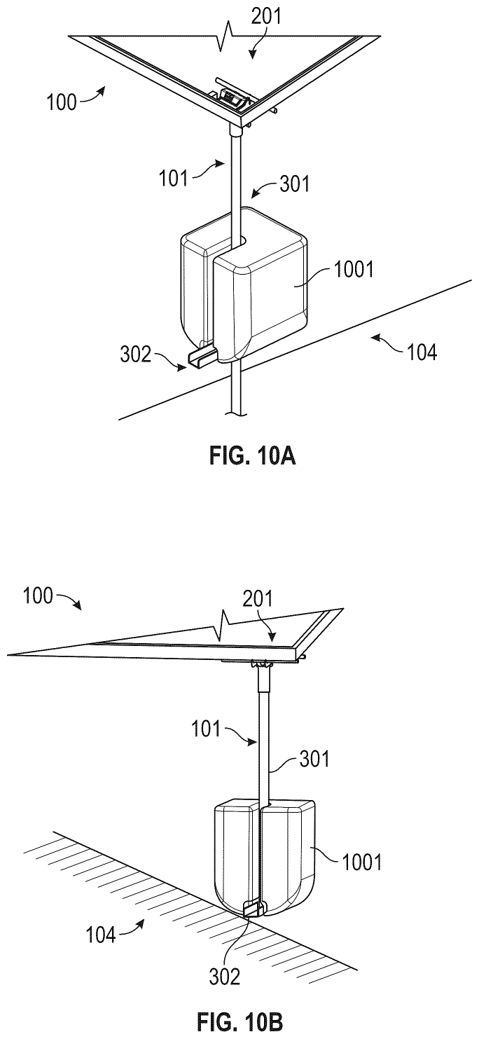

FIGS. 10A-10B depict an isometric view and a side isometric view of an exemplary ballast container 1001 installed onto an exemplary stilt assembly 101. Ballast container 1001 may slide over a stilt 301 and may have a cavity configured to rest on ground brace 302. Ballast container 1001 may be a hollow chamber that is fillable with a material such as water or sand or gravel or dirt in order to provide a ballasted weight for solar module array 100. Stilt 301 may not extend into installation surface 104 in this example embodiment, or it may partially extend into installation surface 104 in order to provide resistance from lateral forces. Ballast container 1001 may have curved underside surfaces that curve up from the length of a ground brace 302 in order to not interfere with a sloped installation surface 104 and better contact installation surface 104. Ballast container 1001 may be a polymer or a metal material and may have an opening on the top to readily fill with a ballast material such as sand or it may have a cap that is releasable and closable in order to fill with a liquid such as water and seal the ballast container 1001 to slow the rate of evaporation. In some examples, Ballast container 1001 may have an interference fit with stilt 301 or a snap fit or it may be secured to stilt 301 through one or more latches, clasps, threadably engaged fasteners, straps, brackets, or clips. Ballast container 1001 may be installed in the corner stilt assembly 101 of a solar module array 100 or may be installed on every alternating stilt assembly 101 within a column of stilt assemblies 101 or it may be installed on all stilt assemblies 101 within a solar module array 100.

In an example installation sequence of a stilt assembly 101, a stilt 301 may be driven into installation surface 104 using a tool that hammers down, rotates, or vibrates the stilt 301 into installation surface 104. Next, ground brace 302 may be placed on or around or over a stilt 301 and lowered to be coincident with an installation surface 104. Ground brace 302 may be rotated around the primary axis of stilt 301 in order to maximize surface contact with installation surface 104. Then, brace crimp tube 317 may be secured to stilt 301 using a crimp or a threaded connection or a pin or a jamming component. Next, support assembly 300 may be placed over or onto stilt 301 to a desired height and rotated so that rounded beams 305 are substantially in line with other rounded beams 305 in the same column of stilt assemblies 101. Support crimp receiver 310 may be crimped or secured to stilt 301, or one or more set screw 307 may be threadably engaged with support receiver 306 in order to secure support assembly 300 to stilt 301. Support bracket 304 may be rotated around pivot axel 311 to be substantially parallel with the average slope of installation surface 104.

In an example installation procedure of solar module array 100, the horizontal distances between stilt assemblies 101 in the north-south and East-West directions may be calculated based on a desired angle of a west facing module 201 and an east facing module 202. In some examples, the stilt assemblies 101 may be positioned a distance apart to achieve a module tilt angle (e.g., less than 20 degrees) of the solar energy module relative to the horizon. The horizontal north-south spacing between a pair of stilt assembly 101 in a column of short stilt assemblies 102 or between a pair of stilt assemblies 101 in a column of tall stilt assemblies 103 may be substantially equal to the length of a solar module, no matter the angle of installation surface 104. The horizontal east-west spacing between a pair of stilt assemblies 101 may be equal to the width of a solar module multiplied by the cosine of the angle relative to the horizon of the solar module. These dimensions may be calculated with a software program.

In an example installation procedure, the positions of a plurality of stilt assemblies 101 may be measured using a provided instruction sheet showing the horizontal north-south and east-west dimensions between two or more stilt assemblies 101. The positions may be marked on installation surface 104 to indicate the installation location of the plurality of stilts 301, and then the plurality of stilts 301 may be installed into installation surface 104. In another example layout procedure, a stilt 301 located at each end of a column short stilt assemblies 102 may be installed into the ground, and then a string line or laser may span between each of the oppositely positioned stilts 301. Intra-column stilt assemblies 101 may then be installed using the string line as a guide to ensure all stilt assemblies 101 within a column of short stilt assemblies 102 or tall stilt assemblies 103 are substantially in line with one another. In this example procedure, the string line may be positioned at a similar distance above installation surface 104 to indicate how far to install the intra row stilts 301 into installation surface 104.

A first west facing module 201 may be positioned onto a first pair of stilt assemblies 101 in a column of short stilt assemblies 102 and a first pair of stilt assemblies 101 in a column of tall stilt assemblies 103. Each of the stilts 301 in the respective stilt assembly 101 may flex in order for each of the support assemblies 300 to be fully coincident with their respective edges of a west facing module 201 or east facing module 202. Next, one or more module clips 303 may be installed onto rounded beam 305 in order to secure west facing module 201 to all four stilt assemblies 101. Then, a second to solar module is installed onto a third pair of stilt assemblies 101 and second pair of stilt assemblies 101 in each of the columns of short stilt assemblies 102 and tall stilt assemblies 103.

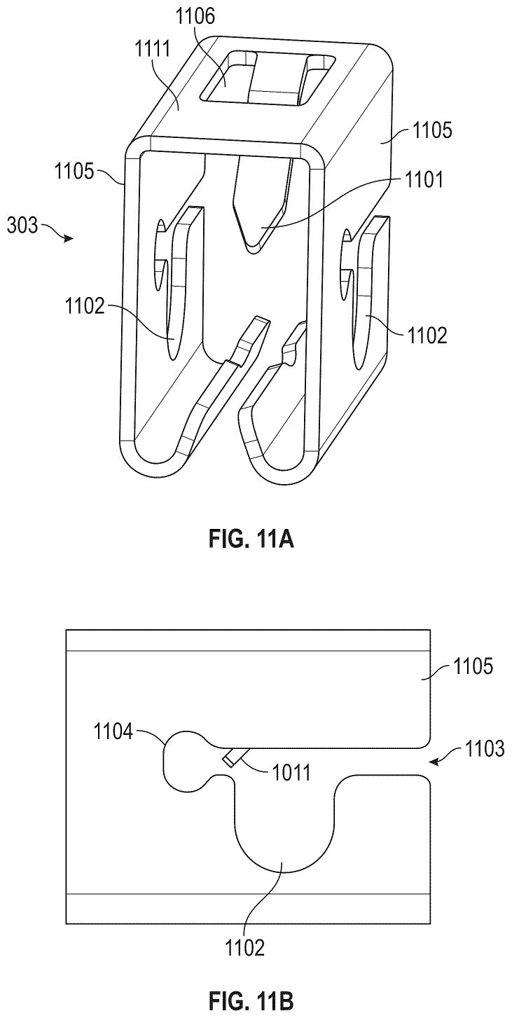

FIG. 11A-11B depict a front isometric view and a side view of an exemplary module clip 303. Module clip 303 may be formed out of a uniform thickness material such as a sheet metal, or it may be non-uniform if cast. In some examples, module clip 303 may be stainless steel, pre-coated steel, hot dip galvanized steel, aluminum. module clip 303 may have two vertical flanges 1105 connected by a main horizontal body on the top edge. Horizontal body aperture 1106 may be disposed in horizontal body 1111 and have a size configured to allow for easily flexing a first vertical flange 1105 toward or away a second vertical flange 1105 with a tool or with hand pressure. In other words, horizontal body aperture 1106 may sufficiently reduce the cross-sectional area of horizontal body 1111 to an amount that achieves the desired force required to flex a first vertical flange 1105 towards or away a second vertical flange 1105 a desired distance. Bond spike 1101 may protrude down from an inner edge of horizontal body aperture 1106 or from a different edge of module clip 303. Bond spike 1101 may have a sharp point configured to pierce a coating on a solar module frame. Bond spike 1101 may have angled edges on either side of the point, as depicted, and may protrude down from a top main portion of module clip 303 at an angle relative to the horizontal. One or more connection aperture 1102 may be disposed through a first and or a second vertical flange 1105. Connection aperture 1102 may be configured to receive rounded beam 305 and allow for module clip 303 to readily rotate around the primary axis of rounded beam 305. Module flange gap 1103 may be disposed through one or more vertical flanges 1105 and configured to receive a horizontal flange of a solar module frame. Module flange gap 1103 may have a vertical distance to readily slide onto a standard solar module frame flange, yet not so large as to allow excessive movement of the solar module flange. Module flange gap 1103 may be open on a first side of vertical flange 1105 as shown FIG. 11B and stress relief aperture 1104 may be at an opposite distal end of module flange gap 1103. Stress relief aperture 1104 may have one or more curvatures with a radius sufficient to prevent rupture or tearing or cracking or similar mode of failure when a solar module is pulled up against a stationary stilt assembly 101, such as during the uplift from high wind flow. As shown in FIG. 11B, bond spike 1101 may protrude down past the upper wall of module flange gap 1103 thereby providing compressive force between the bottom edge of module flange gap 1103 and a solar module frame when installed onto a rounded beam 305 with a module clip 303. Bond spike 1101 may be positioned at a mid-elevation along the vertical distance of vertical flange 1105, as depicted, or may be biased to an upper portion or a lower portion of vertical flange 1105.

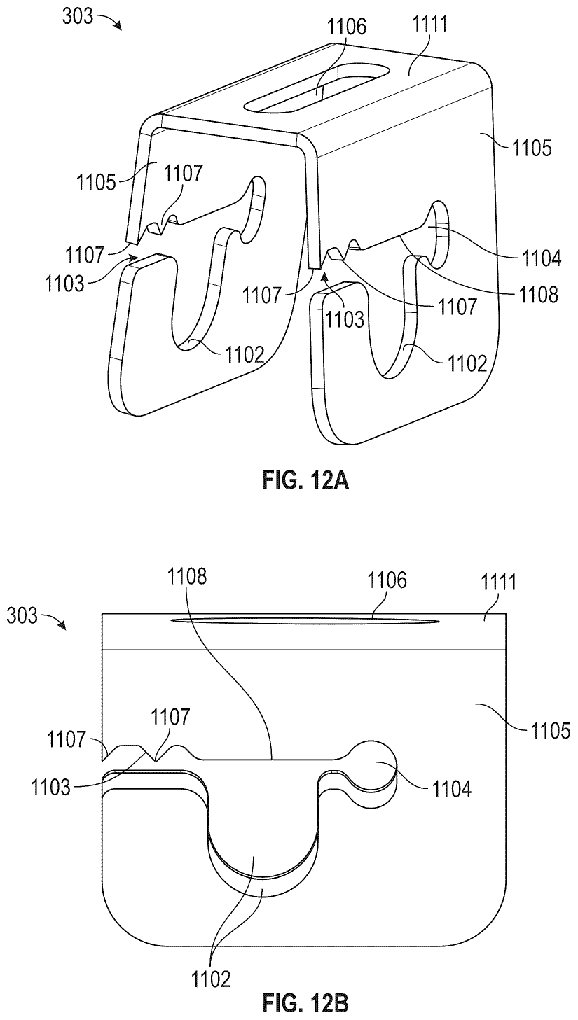

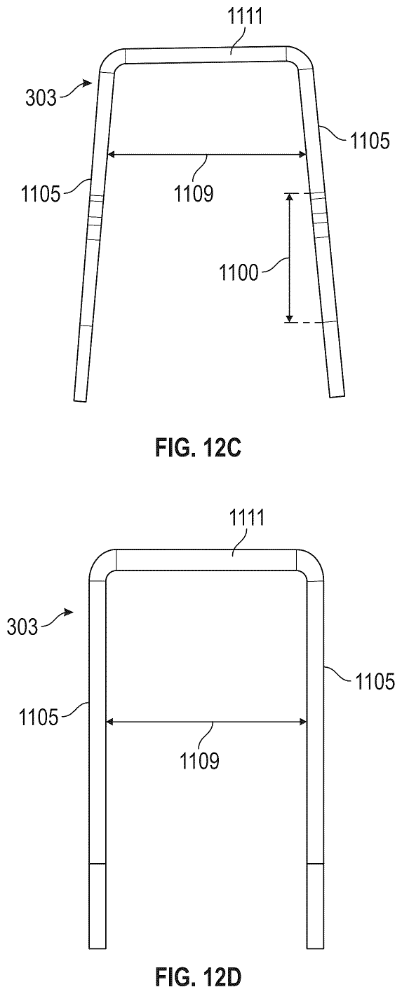

FIGS. 12A-12C depict a side isometric view, a side view, a front view of an exemplary module clip 303 with vertical flanges configured at an angle.

FIG. 12D depicts a front view of an exemplary module clip with vertical flanges.

In the example embodiment shown in FIGS. 12A-12C, module clip 303 has all of the same elements as the module clip 303 in FIGS. 11, however the one or more vertical flanges 1105 are configured at a flange angle 1109 in an uncompressed state or configuration. Further, stress relief aperture 1104 may have one or more bond teeth 1107 disposed at an opening end of stress relief aperture 1104. Bond teeth 1107 may be configured to pierce a coating of a solar module flange in order to provide an electrical bond path between module clip 303 and the solar module and thereby provide an electrical bond path from a solar module to stilt assembly 101. When a first and second west facing module 201 and a first and second east facing module 202 are installed on a stilt assembly 101 with four module clips 303, then all four solar modules may be electrically bonded to one another. Bond teeth 1107 may protrude beyond edge 1108 in order to provide a first contact point with a solar module frame upon installation. In an uncompressed state where flange angle 1109 is greater than zero, for example at 10 degrees, the vertical distance 1110 may be equal to or less than the total thickness or height of a vertical distance of rounded beam 305 plus the thickness of a solar module flange 1301. When module clip 303 is in a compressed state wherein flange angle 1109 is substantially equal to zero, then vertical distance 1110 may be greater than the total vertical distance or total thickness of a solar module flange 1301 resting on top of rounded beam 305. In this way, when module clip 303 is in a compressed state, as shown in FIG. 12D, module clip 303 may readily slide onto the end of a rounded beam 305 with a solar module frame resting on top of rounded beam 305. Then when the lateral compressive force is released to allow module clip 303 to spring back to an uncompressed state, for example as shown in FIG. 12C, then module clip 303 may compress a solar module flange onto a rounded beam 305 and may force bond teeth 1107 to pierce a coating on a solar module flange and electrically bond the solar module to stilt assembly 101. In other example embodiments not shown module clip 303 may be in a compressed state when flange angle 1109 is at a smaller positive or negative angle relative to when module clip 303 is in an uncompressed state.

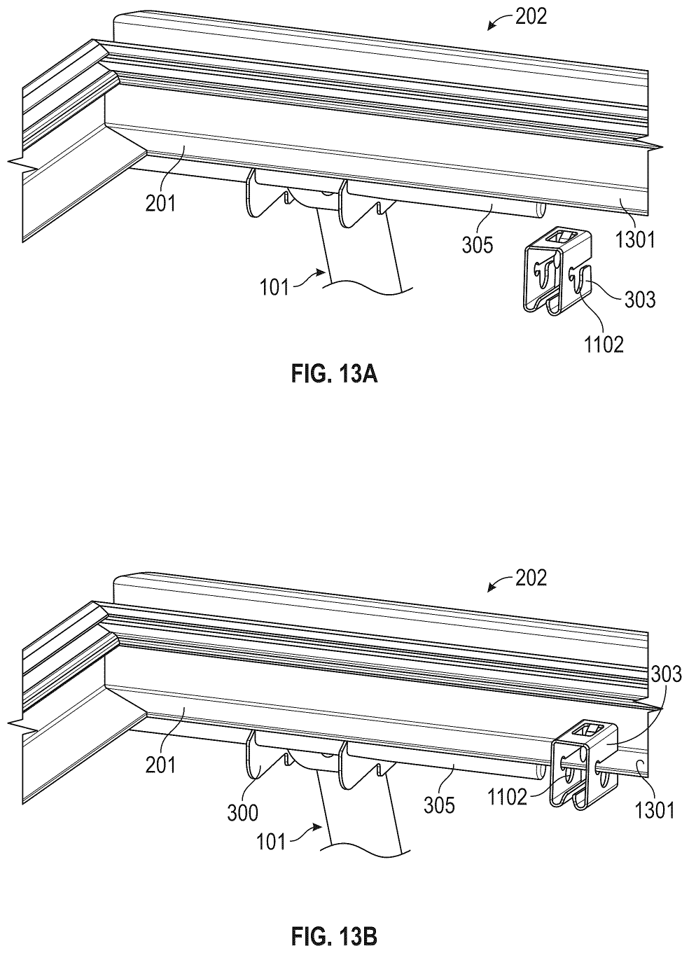

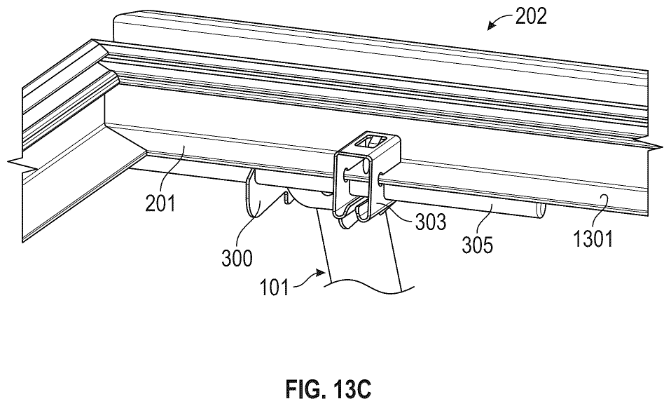

FIGS. 13A-13C depict an exemplary installation sequence of a module clip 303 onto a rounded beam 305 with a west facing module 201 installed onto a stilt assembly 101. The sequence is representative of the installation sequence for the two example embodiments of module clips 303 depicted in FIGS. 11 and 12. This installation sequence may also be the same for west facing module 201 or east facing module 202 or south-north facing module 205. In FIG. 13A, module clip 303 is positioned near a rounded beam 305 that has west facing module 201 already placed on top. In FIG. 13B, module clip 303 is first slid over module frame flange 1301 until connection aperture 1102 is substantially aligned with the axis of rounded beam 305. In some example methods, module clip 303 may also be slid onto module frame flange 1301 until module frame flange 1301 abuts the inner edge of stress relief aperture 1104. If installing module clip 303 as depicted in FIG. 12D, module clip 303 may be in a compressed state at this step of the installation sequence. In FIG. 13C, module clip 303 is slid laterally along module frame flange 1301 and over rounded beam 305 until rounded beam 305 protrudes through module clip 303. In the example embodiment of module clip 303 from FIG. 12D, module clip 303 may be in a compressed state temporarily while slid laterally until in a desired position, at which point module clip 303 would be released to flex back to an uncompressed state. Upon being released to flex back to an uncompressed state, module clip 303 may compress module frame flange 1301 onto rounded beam 305 and may also electrically bond west facing module 201 to stilt assembly 101. In some example methods, module clip 303 may be slid all the way along rounded beam 305 until substantially coincident with either a perpendicular solar module frame or until substantially coincident with support assembly 300.

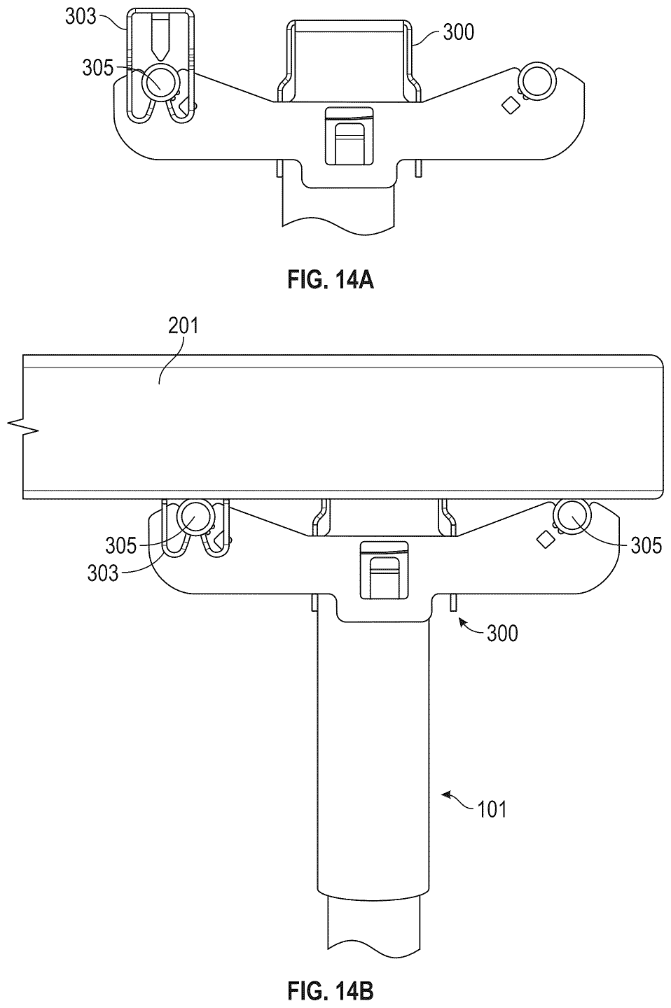

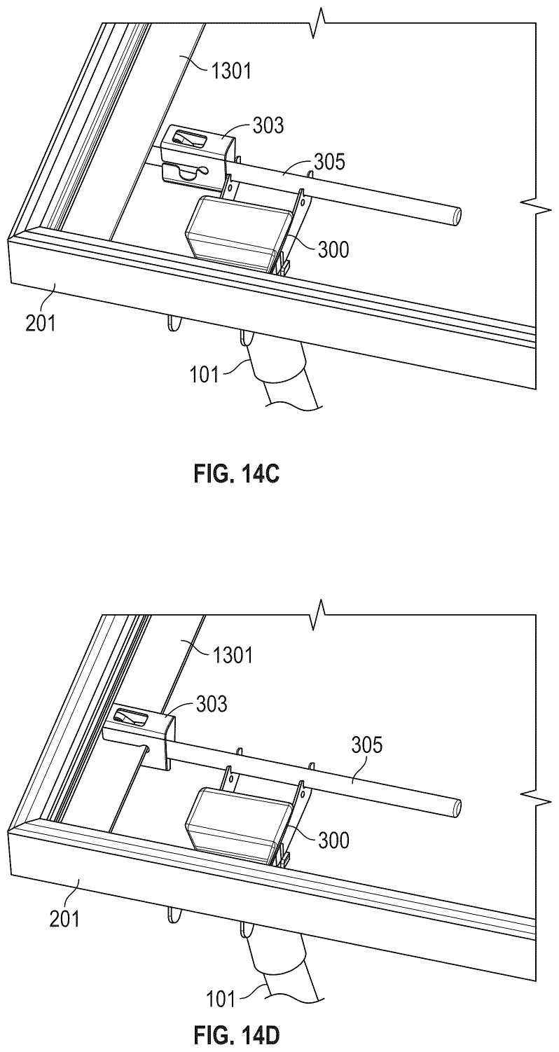

FIGS. 14A-14D depict an exemplary installation method of module clip 303 onto stilt assembly 101 and west facing module 201. In this example embodiment, module clip 303 may be slid lengthwise on to rounded beam 305 into an initial position as shown in FIGS. 14A and 14C. In this example method module clip 303 is slid lengthwise onto rounded beam 305. West facing module 201 may be placed onto one or more rounded beams 305 as depicted in FIGS. 14B and 14D and then module clip 303 may be slid in the reverse direction along rounded beam 305 until module frame flange 1301 is captured within module flange gap 1103 and bond spike 1101 pierces the coating on module frame flange 1301. In some example methods, module frame flange 1301 may extend all the way up and abut the inner edge of stress relief aperture 1104.

FIGS. 15A-15C depict exemplary embodiments of a short symmetric support 1501, a tall symmetric support 1502, and an end support 1503. Each of the supports can be configured to install on a flat installation surface, where each embodiment may be used together or separately to install a solar module array 100.

FIG. 15A depicts an exemplary configuration of a short symmetric support. Short symmetric support 1501 may be formed with support beam body 1510 and a first support beam upright 1511 and second support beam upright 1512 at opposite distal ends. In some examples, support beam body 1510 may have a “C” shape, “D” shape, square, rectangular, trapezoidal, “Z” shape, circular, or complex. Support beam body 1510 may be bent or curved upright on either end to form first support beam upright 1511 and second support beam upright 1512. In other example embodiments, first support beam upright 1511 and second support beam upright 1512 may be separate components that are fastened to a support beam body 1510 through welds, fasteners, rivets, latches, or sleeves. Support beam body 1510 may be made of a uniform thickness material, such as a sheet metal, and may be made of stainless steel, pre coated steel, post coded steel, aluminum, a polymer, or fiberglass impregnated resin. In some example embodiments, the cross-sectional area may permanently deform at the transition points or curves or bends connecting first support beam upright 1511 to the main section of support beam body 1510. Near the distal end of first support beam upright 1511 and second support beam upright 1512 an aperture may be disposed configured to receive rounded beam 305. Tall symmetric support 1502 may be a variation of short symmetric support 1501 wherein support beam body 1510 is longer horizontally and both first support beam upright 1511 and second support beam upright 1512 are longer than in the configuration of short symmetric support 1501. The angle between first support beam upright 1511 and support beam body 1510 may be 90° or it may be an obtuse angle as shown or may be an acute angle. Similarly, the angle between second support beam upright 1512 and support beam body 1510 may be 90° or it may be obtuse, or it may be an acute angle.

As shown in FIG. 15C, end support 1503 may be formed as end support beam 1513 with a central upright configured to receive rounded beam 305. As depicted, the central upright may not encompass the perimeter of rounded beam 305 in order to avoid interference with the underside of a solar module frame when installed. In this example embodiment, end support beam 1513 is a “C” shaped channel that is formed out of a uniform thickness material, such as steel, stainless steel, or aluminum, though other cross-sectional shapes, such as a tube or flat plate, can be used.

In some example embodiments, short symmetric support 1501, tall symmetric support 1502, end support 1503, asymmetric support 1504 may have one or more apertures disposed through an underside surface or through a side wall or through a top wall configured to connect a protective pad such as a rubber material or a slip sheet intended to reduce wear on installation surface 104. In other example embodiments, the supports are configured to receive a connection through a fastener or a flange or a locking joint to a bracket that secures solar module array 100 to installation surface 104, such as via a fastener. In other example embodiments, the supports are configured to rest on a substantially flat rooftop surface that may be made from a TPO, PVC, or asphalt. In other example embodiments, the supports are configured to be held down by ballast, such as blocks of concrete or tubs of sand, gravel, or water, using a sufficient amount of mass to prevent solar module array 100 from moving due to high wind speeds or seismic vibrations. In other example embodiments not shown, second support beam upright 1512 or first support beam upright 1511 may be configured to have a wind deflector coupled onto and between one or more tall symmetric support 1502 to deflect wind away from the underside of a solar module.

FIG. 15D depicts an exemplary configuration at the end of an asymmetric support with one or more apertures disposed through a top wall configured with a lock piece 1514 and a rounded beam 305. As shown in 15D, lock piece 1514 may secure rounded beam 305 to first support beam upright 1511. In some example embodiments, lock piece 1514 may be compressed laterally in order to allow rounded beam 305 to slide laterally through the one or more apertures disposed in first support beam upright 1511. In other example embodiments, rounded beam 305 may be permanently installed into support beam body 1510 through a spot-weld, a crimp, a flange, a glue, or bend in rounded beam 305. In all example embodiments, a first rounded beam 305 may electrically bond to a second rounded beam 305, thereby providing an electrical bond path between two or more solar modules installed onto a support.

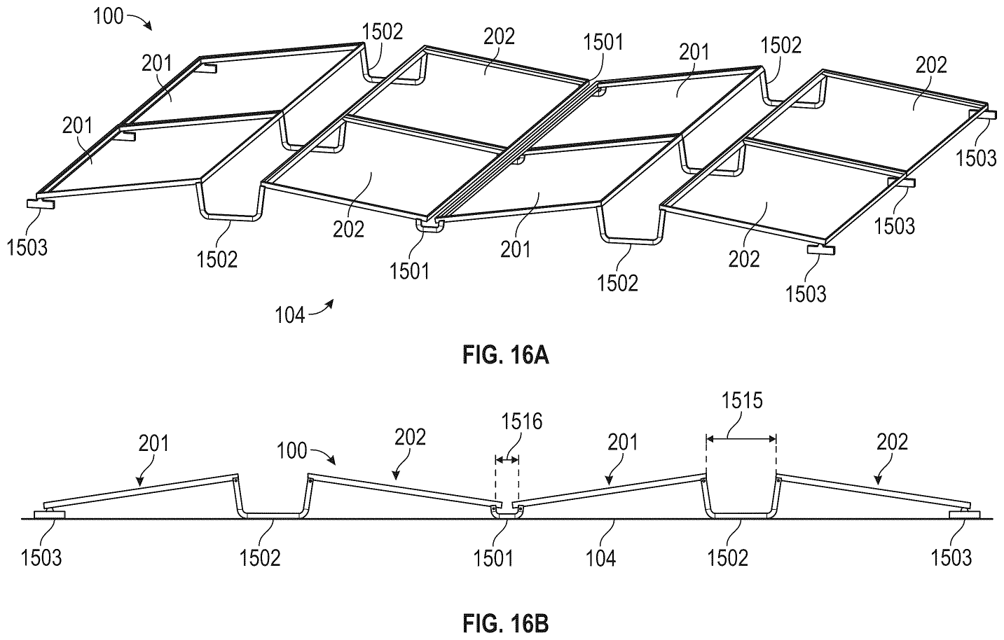

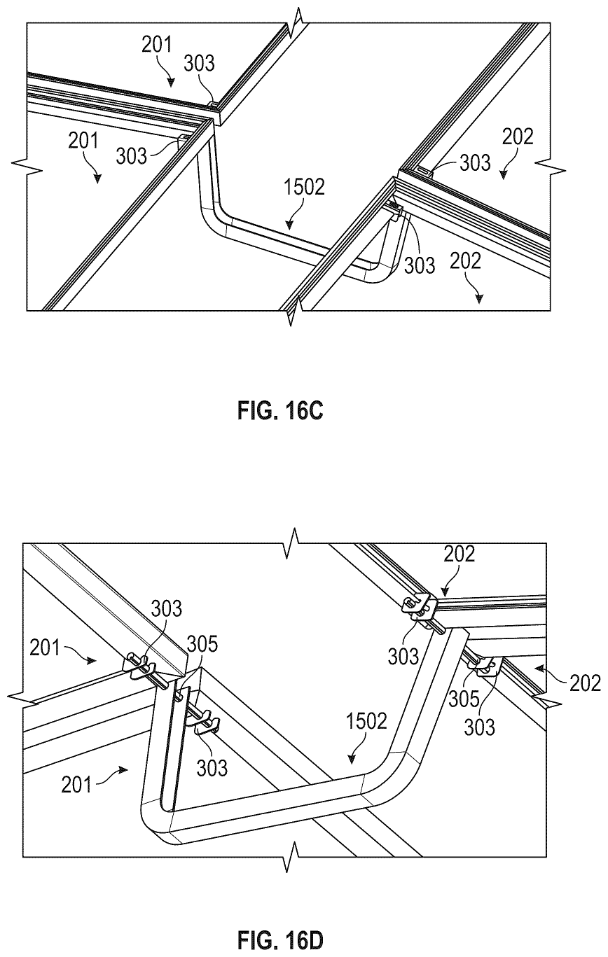

FIGS. 16A-16B depict an isometric view and a side view of an exemplary solar module array 100 configured with solar modules at angled orientations. As depicted in FIG. 16A, a first column of end supports 1503 are disposed on an installation surface 104, followed by a column of tall symmetric supports 1502, followed by a column of short symmetric supports 1501, followed by a column of tall symmetric supports 1502, and then finally a column of end supports 1503. A solar module array 100 where the modules are configured in an east-west orientation may have a pattern where the West and East columns of supports are a column of two or more end supports 1503, then the supports between the east and west distal ends of solar array 100 are columns of supports alternating between tall symmetric supports 1502 and short symmetric supports 1501. In this way, the solar modules alternates between a west facing module 201 configuration and east facing module 202 configuration. The width of support beam body 1510 may be short in order to minimize thin row gap 1516 between east facing module 202 and west facing module 201. However, support beam body 1510 in a short symmetric support 1501 may be wide enough to allow snow and debris to readily drain or fall between a column of east facing modules 202 and a column of west facing modules 201. In tall symmetric support 1502, support beam body 1510 may have a horizontal distance sufficient to provide a gap large row gap 1515 between a column of west facing modules 201 and a column of east facing modules 202 in order for a person to walk between the two columns of solar modules.

FIGS. 16C-16D depict a close-up top isometric view and underside isometric view of an exemplary support installed with four solar modules. One or more solar modules would be installed in a similar method on short symmetric support 1501 and end support 1503. As depicted, the solar modules are secured to tall symmetric support 1502 with module clips 303 clamping, securing, or electrically bonding, or a combination thereof, the solar module onto rounded beam 305. In this way, the solar modules may be disposed at any angle relative to support beam body 1510 as they are able to articulate around the curved surface of rounded beam 305 while being fully supported. One exemplary feature is the ability for the solar modules to be fully secured to a support at any angle relative to the support around the primary axis of a rounded beam 305. In this way, installation surface 104 does not need to be a perfectly flat plane, but rather can undulate or be at an angle or be curved in an east-west direction while the solar energy modules to be fully secured and columns of west facing modules 201 to be substantially parallel with one another and columns of east facing modules 202 to be substantially parallel with one another.

In an example installation sequence, a series of supports may be laid out on installation surface 104. Then a first west facing module 201 may be installed to a pair of end support 1503 using module clips 303 at each corner of a first west facing module 201. During this initial installation sequence, west facing module 201 may be in a vertical orientation or large angle relative to installation surface 104, such as greater than 45 degrees, for easy access to the underside of the panel. Then west facing module 201 may be lowered down, rotating around the primary axis of rounded beam 305, until the opposite side of west facing module 201 rests on one or more rounded beam 305 on a tall symmetric support 1502. Then one or more module clips 303 may be installed to secure the first west facing module 201 onto one or more tall symmetric supports 1502. Subsequent solar modules within the column may be installed in a similar fashion. A first east facing module 202 in a next column may be installed in a similar fashion or in a opposite direction wherein the east edge of east facing module 202 may be secured to short symmetric support 1501 via one or more module clips 303 when east facing module 202 is at a large angle relative to installation surface 104. Then east facing module 202 may be lowered onto one or more rounded beams 305 of a first tall symmetric support 1502 and secured to one or more tall symmetric supports 1502 via one or more module clips 303. At this step, first tall symmetric support 1502 is supporting a first west facing module 201 and a first east facing module 202. Subsequent east facing modules 202 within the column may be installed in a similar fashion. In other example methods, the supports may be placed and positioned as solar module array 100 is assembled in columns and rows. In other words, a first pair of end supports 1503 may be placed on installation surface 104 and secured to a first pair of tall symmetric supports 1502 and then subsequent supports of the configurations of end supports 1503, tall symmetric supports 1502 and short symmetric supports 1501 are positioned for additional solar modules.

In an example method of repairing, replacing or otherwise servicing a solar module, a first pair of module clips 303 may be disengaged from a first west facing module 201 on a first pair of tall symmetric supports 1502. Then west facing module 201 may be articulated away from installation surface 104 around the primary axis of the rounded beam 305 on one or more end supports 1503 or on one or more short symmetric supports 1501 in order to access the underside of west facing module 201 or to access and remove a second set of module clips 303 on end supports 1503 or short symmetric supports 1501 in order to fully remove west facing module 201. A replacement west facing module 201 may be reinstalled in the same way as previously described. The same sequence is anticipated for an east facing module 202 or a south-north facing module 205.

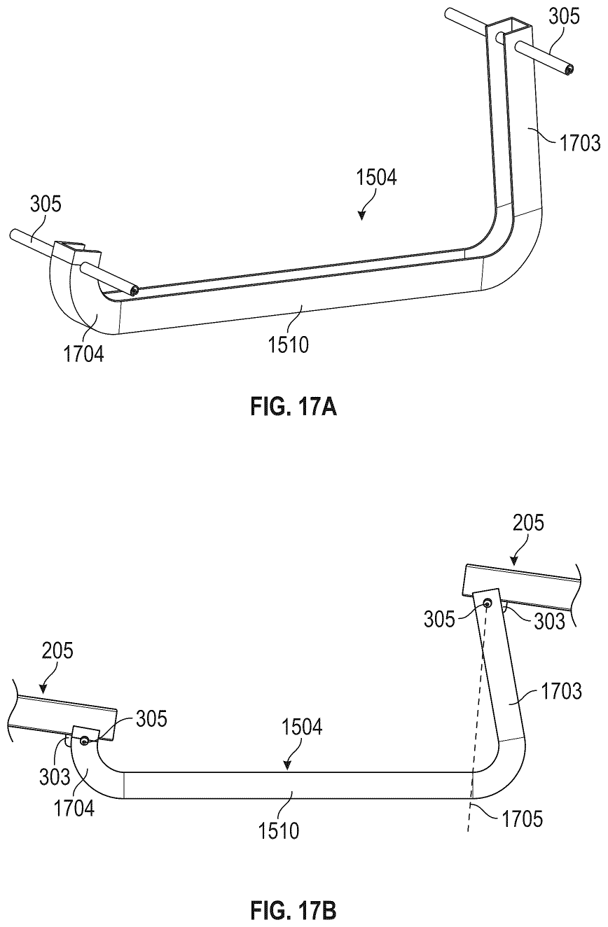

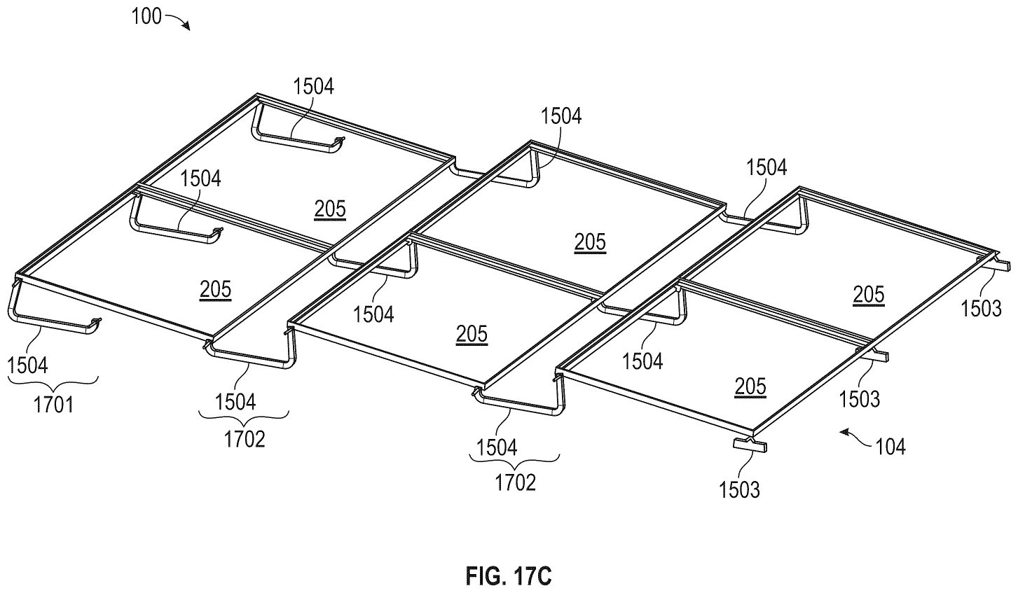

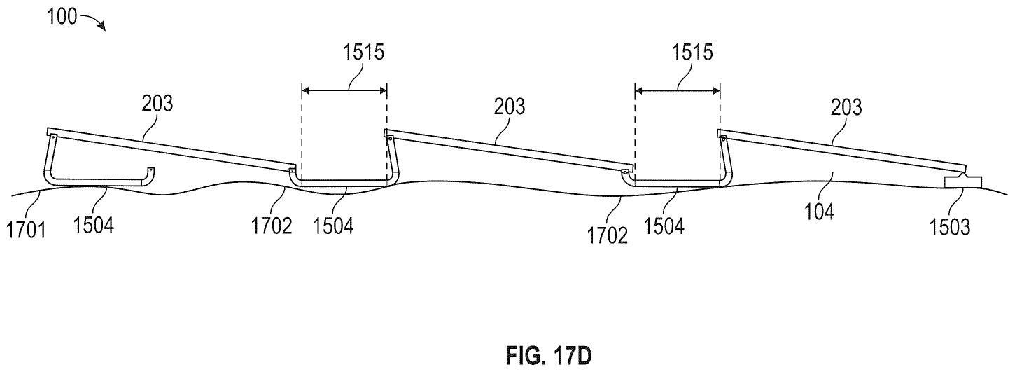

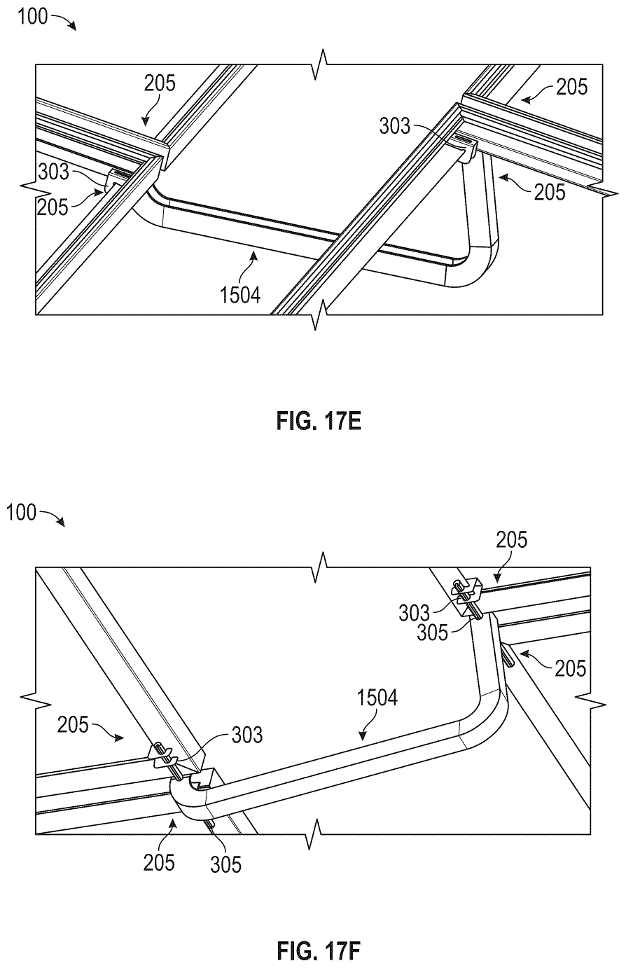

FIGS. 17A-B depict an isometric and a side view of an exemplary asymmetric support 1504. As depicted in FIG. 17A, asymmetric support 1504 has tall upright 1703 protruding upward from one end and short upright 1704 protruding upward from an opposite end. Near the distal end of both tall upright 1703 and short upright 1704 a rounded beam 305 may be disposed through an aperture and secured in place with any of the methods previously described for the configurations in FIGS. 15A-D, with FIG. 15D including a lock piece 1514. As depicted in FIG. 17B, tall upright 1703 and short upright 1704 may be formed with an acute angle relative to support beam body 1510. Tall upright 1703 may have a height and an angle such that rounded beam 305 is substantially vertical or within the flat portion of support beam body 1510. In other words, plum line 1705 that extends vertically down from rounded beam 305 may intersect support beam body 1510 at a flat portion. In this way, as force is pushed down by south-north facing module 205 onto a rounded beam 305 that is installed in tall upright 1703, asymmetric support 1504 may remain flat and not tend to move or rotate.

FIGS. 17C-D depict an isometric and a side view of an exemplary solar module array with a first north support row and two middle support rows positioned on an installation surface.

FIG. 17C shows solar module array 100 with a first north support row 1701 positioned on an installation surface 104 at a distal end of solar module array 100. At an opposite end of solar module array 100 from north support row 1701 a row of end supports 1503 may be disposed on installation surface 104. Between north support rows 1701 and the row of end supports 1503, one or more middle support rows 1702 may be disposed on installation surface 104. North support row 1701 may be comprised of one or more asymmetric supports 1504 position in an opposite, mirror like orientation relative to asymmetric supports 1504 in middle support row 1702 so that short upright 1704 on an asymmetric support 1504 in a north support row 1701 is position underneath East-West stilt spacing 203. In many example embodiments, South-north facing module 205 may generally face in a southward direction, for example anywhere from southwest to southeast when installed in the northern hemisphere, or solar module array 100 and south-north facing module 205 may be angled to face northward, for example northwest to northeast, when solar module array 100 is installed in the southern hemisphere.

As depicted in FIG. 17D, north support row 1701 is at one end of solar module array 100 and a row of end supports 1503 is at an opposite end of solar module array 100. Large row gap 1515 may be formed via the length of support beam body 1510 and may be a dimension suitable to allow easy access by a human or a machine to the backside or higher side of a south-north facing module 205. In some examples, one or more wind deflectors or windshields may be disposed on one or more tall uprights 1703 in a north support row 1701. Tall upright 1703 may be formed at an acute angle relative to support beam body 1510 in order to better deflect wind over a northmost South-north facing module 205.

The matrix of asymmetric supports 1504 and row of end supports 1503 may be installed on an undulating or curved or angled installation surface 104. The curved installation surface of rounded beam 305 allows for South-north facing module 205 to be installed at a plurality of angles relative to support beam body 1510 and thus each asymmetric support 1504 can have a different angle or be installed at different angles from installation surface 104 while still providing the same amount of installation support surface area to a South-north facing module 205 resting on a rounded beam 305. In other words, South-north facing module 205 may have the same support surface area on a rounded beam 305 no matter what angle asymmetric support 1504 is positioned relative to the horizon.

FIGS. 17E and 17F depict an isometric top down and underside view of an asymmetric support 1504 with four South-north facing modules 205 installed. As depicted, a module clip 303 is installed at or near the corners of each of the four South-north facing modules 205 securing each of the South-north facing modules 205 to the two visible rounded beams 305. In these example embodiments, module clip 303 is of the configuration described in FIGS. 12A-12D, but module clips 303 may be in the configuration shown in FIGS. 11A-11B.

In any of the support configurations, short symmetric support 1501, tall symmetric support 1502, end support 1503, and asymmetric support 1504, lock piece 1514 may be disengaged from rounded beam 305 in order to laterally slide rounded beam 305 through one or more apertures in the respective upright supports. In some installation methods, lock piece 1514 may be temporarily disengaged, such as through decompressing, in order to slide rounded beam 305 laterally until substantially coincident with a first aperture disposed in the upright. This may be done for supports located at the perimeter of solar module array 100 so that rounded beam 305 does not protrude significantly beyond the outer border or perimeter of solar module array 100. In other words, the majority of rounded beam 305 may be slid laterally in order to be further underneath a South-north facing module 205 or a west facing module 201 or an east facing module 202 in order to reduce the width or length overall of a solar module array 100.

What is claimed is:

1. A solar energy support system comprising:
one or more stilt assemblies configured to be installed onto an installation surface in a grid pattern, each stilt assembly including stilts extending different heights above the installation surface, and wherein the stilts within the stilt assemblies are arranged so as to alternate heights within the grid pattern; and
one or more module support assemblies each configured to be installed onto a column of one of the stilts so as to be substantially co-planar with one or more other installed module support assemblies, wherein each module support assembly includes a securing mechanism configured to secure a solar energy module.

2. The system of claim 1, wherein heights of the substantially co-planar module support assemblies are within 100 mm of each other.

3. The system of claim 1, wherein each of the module support assemblies includes a support bracket and a stilt receiver pivotally connected to the support bracket.

4. The system of claim 1, wherein a distal end of a first stilt in a column of stilt assemblies is co-planar within 100 mm height above the installation surface with a distal end of a last stilt in the same column of stilt assemblies.

5. The system of claim 1, wherein at least one of the stilts is positioned within 500 mm of a corner of the solar energy module.

6. The system of claim 1, wherein all stilts in the stilt assemblies have a same length.

7. The system of claim 1, wherein the different heights of the stilts are based on being installed at different depths relative to the installation surface.

8. The system of claim 1, wherein the stilt assemblies are configured to be positioned at a distance apart to achieve a desired module tilt angle of the solar energy module relative to a horizon.

9. The system of claim 8, wherein the module tilt angle less than 20 degrees relative to the horizon.

10. The system of claim 1, wherein the alternating heights of stilts in the stilt assemblies allows for a solar energy module secured to a first and second column of the stilt assemblies to face a different direction than a solar energy module secured to a second and third column of the stilt assemblies.

11. The system of claim 1, wherein the stilt is made of a flexible material that accommodates a distal end of the stilt being at a different location in an x-y plane than a location of penetration into the installation surface by the stilt after one or more solar energy modules are installed onto the module support assemblies.

12. The system of claim 1, wherein the stilt is flexible and allows at least 10 mm of offset in an x-y plane between the distal end and a location of penetration into the installation surface.

13. The system of claim 1, further comprising a ground brace configured to be installed onto the stilt so as to abut the installation surface.

14. A solar energy support system comprising:
a plurality of stilts configured to be installed vertically into a sloped installation surface; and
a plurality of module support assemblies, each support assembly including:
a support bracket that is angled relative to a stilt at an angle substantially equal to an average incline angle of the installation surface;
a receiver pivotally attached to the support bracket; and
a support mechanism configured to secure a solar energy module to the support assembly.

15. The system of claim 14, wherein the stilts configured to be installed into the installation surface in a grid pattern.

16. The system of claim 14, wherein the stilts extend to different heights above the installation surface, and wherein the stilts are arranged in an alternating pattern of the different heights along an east-west direction.

17. The system of claim 14, wherein the installed module support assemblies within a column of module support assemblies are co-planar within 100 mm of one another.

18. The system of claim 14, further comprising a ground brace configured to be installed onto the stilt so as to abut the installation surface.

19. The system of claim 14, wherein the stilt is made of a flexible material that accommodates the distal end of the stilt being at a different location in an x-y plane than a location of penetration into the installation surface by the stilt after one or more solar energy modules are installed onto the module support assemblies.

20. The system of claim 19, wherein the stilt is flexible and allows at least 10 mm of offset in an x-y plane between the distal end and a location of penetration into the installation surface.

21. The system of claim 14, wherein the receiver includes a tube configured to receive one of the stilts, and wherein the receiver is secured onto the stilt by crimping.

22. The system of claim 14, wherein the stilt is made of solid steel, and wherein a surface of the stilt includes one or more ribs.

23. The system of claim 14, wherein the support bracket is made from a steel sheet of a uniform thickness.

24. The system of claim 14, wherein adjacent solar modules are electrically bonded through a first securement mechanism on a first one of the adjacent solar modules, through a support bracket, and through a second securement mechanism on a second one of the adjacent solar modules.

25. A solar energy support system comprising:
a plurality of stilts configured to be installed onto an installation surface;
a support assembly configured to attach to a distal end of end of each stilt, the support assembly including:
a stilt receiver;
a support bracket associated with two or more rounded beams; and
a securing mechanism that secures one or more solar energy modules to the rounded beams at angles between-45 and 45 degrees.

26. The system of claim 25, wherein the stilt receiver is configured to pivotally attach to the support bracket.

27. The system of claim 25, wherein the stilt receiver is attached to the support bracket with a riveted connection.

28. The system of claim 25, wherein the stilt receiver includes a tube, and wherein the stilt receiver is secured onto the stilt by crimping.

29. The system of claim 25, wherein the stilt is made of solid steel, and wherein a surface of the stilt includes one or more ribs.

30. The system of claim 25, wherein the securing mechanism includes a module clip configured to pivotally attach to the support assembly.

31. The system of claim 25, wherein the support bracket is made of a steel sheet of a uniform thickness.

32. A method of installing solar energy support system, the method comprising:
installing a stilt of one or more stilt assembly into an installation surface;
placing a ground brace around the stilt at a location coincident with the installation surface;
placing a support assembly onto the stilt, wherein the support assembly includes a plurality of rounded beams; and
rotating the support assembly to place the rounded beams substantially in line with other rounded beams in a column of stilt assemblies.

33. The method of claim 30, wherein the support assembly includes a receiver that receives the stilt, and wherein the receiver is crimped.

34. The method of claim 31, wherein the support assembly includes a support bracket pivotally connected to the receiver.

35. The method of claim 32, further comprising rotating the support bracket around a pivot axle to be substantially parallel to an average slope of the installation surface.

36. The method of claim 30, further comprising securing solar energy modules onto the support assembly with a securing mechanism of the support assembly.

37. The method of claim 30, wherein the stilt is made of a flexible material that accommodates a distal end of the stilt being at a different location in an x-y plane than a location of penetration into the installation surface by the stilt after one or more solar energy modules are installed onto the module support assemblies.

38. A method of installing a solar energy support system, the method comprising:
marking positions for installing a plurality of stilts on an installation surface, wherein the plurality of stilts support one or more solar energy modules;
installing a first stilt of the plurality of stilts and a last stilt of the plurality of stilts into the installation surface so that distal ends of both stilts are at substantially a same distance above the installation surface;
positioning a string line at a distance relative to the distal ends of the first stilt and the last stilt; and
installing intra-column stilts of the plurality of stilts into the installation surface to a depth so that the distal ends of the intra-column stilts are substantially the same distance above the string line as the first and last stilt.

39. The method of claim 36, further comprising securing the solar energy modules onto a support assembly, wherein the support assembly is assembled into a column of each stilt at a distal end of the stilt with a securing mechanism of the support assembly.

40. The method of claim 36, wherein the stilt is made of a flexible material that accommodates a distal end of the stilt being at a different location in an x-y plane than a location of penetration into the installation surface by the stilt after one or more solar energy modules are installed onto the module support assemblies.
